(19) United States
(12) Patent Application Publication
(10) Pub. No.: US 2026/0043692 A1
(43) Pub. Date: Feb. 12, 2026

(54) METHOD AND SYSTEM FOR PRODUCING FLUORESCENCE SENSORS

(71) Applicant: Osensa Innovations Corp., Burnaby (CA)

(72) Inventor: Daryl JAMES, Coquitlam (CA)

(21) Appl. No.: 19/067,963

(22) Filed: Mar. 2, 2025

Related U.S. Application Data
(63) Continuation-in-part of application No. 18/591,650, filed on Feb. 29, 2024.

(51) Int. Cl. G01K 11/20

(52) U.S. Cl. CPC G01K 11/20

(57) ABSTRACT

Ingredients of a fluorescent material are selected and apportioned to yield a fluorescence lifetime that varies monotonically within a specified range of temperatures of the fluorescent material. The fluorescent material includes both inert ingredients and active tuning ingredients that monotonically influence the dependency of fluorescence lifetime on temperature. The invention provides a method of adjusting a selected fluorescence material to result in variation of fluorescence lifetime with temperature that closely adhere to a monotonic reference function, of fluorescence lifetime versus temperature, that is specific for a temperature-range of interest. The reference function may be monotone-decreasing or monotone-increasing. On a manufacturing scale, fluorescent materials, thus adjusted, can be used to produce temperature sensors that are backward compatible. A system implementing the method employs a chemical-processing facility, an apparatus for measuring fluorescence lifetime, and a computation module for determining requisite adjustments to be fed back to the chemical facility.

### CROSS-REFERENCE TO RELATED APPLICATIONS

The present application is a continuation-in-part of U.S. patent application Ser. No. 18/591,650 filed on Feb. 29, 20 [symbol] application PCT/CA2020/000004 filed on Jan. 21, 2020, which claims the benefit from the U.S. patent provisional application 62/812,843 filed on Mar. 1, 2019. The entire contents of the above noted patent applications are incorporated herein by reference.

### FIELD OF THE INVENTION

The invention relates to fluorescence thermometry. In particular, the invention is directed to producing temperature sensors that obey a prescribed relationship of fluorescence lifetime versus temperature.

### BACKGROUND OF THE INVENTION

It is well-known that the fluorescence lifetime of a fluorescent material depends on the inherent properties, hence the composition, of the fluorescent material as well as the temperature of the fluorescent material. This property can be exploited to produce fluorescence-based temperature sensors which have many well recognized advantages. A variety of fluorescent materials, of different mixes of ingredients, may be used to produce temperature sensors even though they may exhibit different functional relationships of fluorescence lifetime to temperature. One of the objects of the invention is to develop methods for producing a fluorescence material having a fluorescence-lifetime versus temperature relationship that closely approximates a reference lifetime versus temperature relationship. Thus, on an industrial scale, temperature sensors would have virtually a same fluorescence-lifetime versus temperature characteristics.

### SUMMARY OF THE INVENTION

An objective of the present invention is to select appropriate ingredients of a fluorescent material, and apportion the ingredients, so that a fluorescence-lifetime versus temperature transfer function of the fluorescent material closely approximates a reference transfer function over a specified temperature range. In the present application, the term “transfer function” is used exclusively to refer to an analytical function relating a fluorescence lifetime (a dependent variable) to temperature (an independent variable) of a fluorescent material.

The fluorescent material is selected to include both inert ingredients and active ingredients. An active ingredient influences the magnitude of fluorescence lifetime. A type-1 active ingredient tends to increase the fluorescence lifetime while a type-2 active ingredient tends to decrease the fluorescence lifetime. It is of paramount importance to select the active ingredients so that the tendency to increase the fluorescence lifetime (for a type-1 ingredient) or decrease the fluorescence lifetime (for a type-2 ingredient) is monotonic over the specified temperature range of interest. To realize a target lifetime, either of the two types of active ingredients can be used. Without knowledge of a precise mathematical model relating lifetime-increment to concentration level for a type-1 ingredient, or lifetime decrement to concentration level for a type-2 ingredient, determining requisite levels of concentration of active ingredients within the fluorescent material is performed adaptively.

In order to compare a transfer function of a current fluorescent material, the fluorescence lifetime is measured at selected pivotal temperatures. A pivotal temperature and a corresponding lifetime are together referenced as a pivotal point. At a first selected pivotal temperature, the composition of the fluorescent material is adjusted so that the ensuing transfer function coincides with the reference transfer function at the first pivotal temperature. Both the so-far attained transfer function and the reference function are monotonic functions. However, coincidence of the two functions at one point does not signify coincidence over the specified temperature range. To evaluate deviation of attained transfer function from the reference transfer function, the fluorescence lifetimes of samples of the fluorescence material, in a current composition, are determined at preselected observation points and a mean value of the magnitudes (absolute values) of deviations from the reference transfer function is determined as an indicator (a positive real number) of discrepancy corresponding to the first pivotal point.

If the indicator is less than a permissible tolerance, the current composition of the fluorescent material is recorded for use in production on a manufacturing scale. Otherwise, more pivotal temperatures may be considered and for each case a respective indicator of discrepancy, based on measurements at the observation points, is determined. The fluorescent material compositions corresponding to individual coincidence at pivotal points and corresponding discrepancy indicators are recorded. As a first-order solution, the fluorescent-material composition corresponding to the least discrepancy indicator may be used in production on a manufacturing scale. As a second-order solution, interpolation of the discrepancy indicators at the pivotal temperatures yields a calculated temperature corresponding to a calculated minimum discrepancy indicator. Subsequently, interpolation of values of concentration of an active-ingredient yields an improved concentration level corresponding to the interpolated temperature.

In accordance with an aspect, the invention provides a method of producing fluorescence-based temperature sensors, implemented in a system performing chemical-processing, fluorescence decay-time measurement, and computation. The method comprises acquiring a reference transfer function relating fluorescence decay-time to temperature over a temperature range and determining a set of pivotal temperatures and a set of observation temperatures within the temperature range.

The fluorescent material includes a tuning ingredient. For each pivotal temperature, a batch of fluorescence material is formed and tuned to have a decay-time equal to a target decay-time determined from the reference transfer function.

A set of samples is extracted from the batch and a current decay-time of the set of samples is determined based on decay-time measurements of individual samples. If the current decay-time differs from the target decay-time, the concentration level of the tuning ingredient of the batch is adjusted, a new set of samples is extracted, until the target decay-time is reached at a specific concentration level, referenced as an appropriate concentration level.

Decay-times, referenced as observation decay-times, of the set of samples at the observation temperatures are then measured and deviations of the observation decay-times from corresponding values of the reference transfer functions are then computed and used to determine a deviation indicator.

An optimal concentration level based on values of the appropriate concentration levels corresponding to the pivotal temperatures is then deduced. The fluorescent material, thus adjusted according to the optimal concentration level of the tuning ingredient, is used to produce the temperature sensors.

The optimal concentration level may be determined as a value of the appropriate concentration corresponding a least deviation indicator. Alternatively, interpolating resulting pairs of deviation indicators and appropriate concentration levels yields the optimal concentration level that corresponds to a minimum deviation indicator.

Adjusting the batch of fluorescent material may be based on increasing a concentration level of the tuning ingredient in equal increments, measuring resulting decay-times, with a last increment calculated to yield a decay-time equal to a target decay-time. Alternatively, adjusting a batch of fluorescent material may be based on adaptively determined increments of the concentration level and measuring resulting decay-times, with a last increment calculated to yield a decay-time equal to a target decay-time. Each adaptively determine increment is a function of prior increments and corresponding decay-times.

The set of pivotal temperatures and the set of observation temperatures may be interleaved. Optionally, at least one pivotal temperature and one observation temperature may coincide. The set of pivotal temperatures and observation temperature can be selected to be identical.

The tuning ingredient is selected to cause a monotonic change of the decay-time over the temperature range.

The deviation indicator may be determined as a mean value of the magnitudes of the deviations of the observation fluorescence decay-times over the set of observation temperatures.

The set of samples contains an appropriate number of samples to produce a statistically significant calculation of decay-time of the fluorescent material based on individual measurements of decay-times of individual samples.

The decay-time of the fluorescent material may be determined as a mean value of measurements of fluorescence decay-times of individual samples of the set of samples. Alternatively, the measurements of decay-times of individual samples of the set of samples may be sorted into a histogram of temperature intervals and the decay-time of the fluorescent material is determined as a mode of the histogram.

In order to ensure homogeneity of the batch of fluorescent material, for at least a first of the pivotal temperatures, a coefficient-of-variation (COV) of current decay-times of individual samples is determined. If the COV exceeds a permissible limit, the ingredients of the fluorescent material are mixed thoroughly to reduce the COV.

To facilitate determining target decay-times corresponding to temperatures of the fluorescent material, the reference transfer function is approximated as one of: (1) concatenated piecewise-linear segments; (2) concatenated piecewise-polynomial segments; and (3) concatenated piecewise-linear segments and piecewise-polynomial segments. Likewise, in order to facilitate translation of the decay-time measurements to temperatures of the fluorescent material, an inverse of said reference transfer function is approximated, in the same fashion, as one of: concatenated piecewise-linear segments; concatenated piecewise-polynomial segments; and concatenated piecewise-linear segments and piecewise-polynomial segments.

If temperature sensors are to be produced for narrower ranges of temperatures, pivotal temperatures and observation temperatures would be selected differently for each temperature range.

The method further comprises retaining batches of the appropriate concentration levels and corresponding decay-time measurements, produced during processes performed for each pivotal temperature, for potential reuse in determining the optimal concentration level.

In accordance with another aspect, the invention provides a system for producing fluorescence-based temperature sensors. The system comprises: a chemical-processing unit; a decay-time measurement unit; and a computation unit.

The chemical-processing unit is configured to form a batch of fluorescence material comprising a tuning ingredient, adjust concentration of the tuning ingredients according to instructions from the computing unit, and extract sets of samples from the batch.

The decay-time measuring unit is configured to measure decay-times of the sets of samples at each of selected temperatures and communicate the decay-time measurements to the computation unit.

The computation unit is configured to acquire a reference transfer function relating decay-time to temperature over a temperature range and determine, from the reference transfer function, for the selected temperatures, respective target decay-times. Upon receiving the decay-time measurements, requisite adjustments of concentration level of the tuning ingredient of the batch to reach the respective target decay-times are computed and communicated to the chemical-processing unit. An optimal concentration level based on received decay-time measurements is then deduced.

The fluorescent material with the optimal concentration level of the tuning ingredient is used to produce the temperature sensors.

The selected temperatures comprise a set of pivotal temperatures and a set of observation temperatures within the temperature range. At a pivotal temperature, the fluorescent material is adjusted so that the decay-time equals a target value based on the reference transfer function.

Deviation of a transfer function, relating decay-times to temperatures of the adjusted fluorescent material, from the reference transfer function is determined at the observation temperatures from which a deviation indicator is determined.

### BRIEF DESCRIPTION OF THE DRAWINGS

Embodiments of the present invention will be further described with reference to the accompanying exemplary drawings, in which:

FIG. 1 illustrates a system for producing fluorescence-based temperature sensors under compatibility constraints; in accordance with an embodiment of the present invention;

FIG. 2 illustrates a variation of the system of FIG. 1 using a central controller;

FIG. 3 illustrates composition of fluorescence material for use in the system of FIG. 1, in accordance with an embodiment of the present invention;

FIG. 4 illustrates requisite constraints under which the temperature sensors are produced;

FIG. 5 illustrates known fluorescence properties enabling temperature measurement;

FIG. 6 illustrates control of the fluorescence properties of FIG. 1 to enable backward compatibility of currently produced temperature sensors, in accordance with an embodiment of the present invention;

FIG. 7 illustrates a reference monotone decreasing function of fluorescence lifetime with respect to temperature of a fluorescence material, which governs production of the temperature sensors;

FIG. 8 illustrates a one-to-one correspondence of a measured fluorescence lifetime to temperature of a respective fluorescence material produced according to the methods of the present invention;

FIG. 9 illustrates increasing or decreasing fluorescence lifetime at a specific temperature of a fluorescence material according to types of the fluorescence material;

FIG. 10 illustrates adjusting contents of a fluorescence material based on measurements of fluorescence lifetime;

FIG. 11 is a flowchart of a method of adaptively adjusting the concentration level of a type-1 tuning ingredient of a batch of the fluorescent material to yield a decay-time closely equal to a target decay-time at a specified pivotal temperature, in accordance with an embodiment of the present invention;

FIG. 12 is a flowchart of a method of adaptively adjusting the concentration level of a type-2 tuning ingredient of a batch of the fluorescent material to yield a decay-time closely equal to a target decay-time at a specified pivotal temperature, in accordance with an embodiment of the present invention;

FIG. 13 illustrates application of the method of FIG. 11 for a case where the target fluorescence lifetime is less than a current lifetime measurement;

FIG. 14 illustrates application of the method of FIG. 12 for a case where the target fluorescence lifetime is less than a current lifetime measurement;

FIG. 15 is a table illustrating variation of fluorescence lifetime variation with both the temperature of a specific fluorescence material and concentration level of tuning content of the specific fluorescence material, the table is used to define a major objective the present invention which is find a concentration level that leads to a monotone decreasing function of fluorescence lifetime with respect to temperature that closely approximates the reference transfer function 750, hence enabling production backward compatibility, in accordance with an embodiment of the present invention;

FIG. 16 illustrates use of a set of observation temperatures for estimating proximity of the attained fluorescence lifetime versus temperature relationship to the reference transfer function 750, based on a measure of deviation of fluorescence lifetime values from corresponding reference values, in accordance with an embodiment of the present invention;

FIG. 17 illustrates use of a set of pivotal points and a set of observation points for estimating proximity of an attained transfer function to the reference transfer function 750, in accordance with an embodiment of the present invention;

FIG. 18 illustrates transfer functions for two independent cases where the fluorescence material is adaptively adjusted to yield fluorescence lifetime values that are precisely close to corresponding reference values of the reference transfer function 750;

FIG. 19 illustrates selection of pivotal points and observation points for different temperature ranges, in accordance with an embodiment of the present invention;

FIG. 20 illustrates a method of determining a concentration level of tuning ingredients of a fluorescent material to yield fluorescence lifetime values that closely approximates corresponding reference values, in accordance with an embodiment of the present invention;

FIG. 21 illustrates interpolation of individual results corresponding to the pivotal points to determine a concentration level yielding the minimum deviation over the temperature range, in accordance with an embodiment of the present invention;

FIG. 22 illustrates formation and adjustments of batches of fluorescence material for production of backward compatible temperature sensors;

FIG. 23 illustrates extraction of samples of fluorescence material to be individually tested for compatibility of decay-times with corresponding reference values;

FIG. 24 illustrates testing of a single sample;

FIG. 25 illustrates discrete approximation of the reference transfer function 750;

FIG. 26 illustrates precision discrete approximation of the reference function of FIG. 7;

FIG. 27 illustrates range-dependent discrete approximation of the reference function 750;

FIG. 28 illustrates a process of ensuring homogeneity of the fluorescence material based on testing individual samples;

FIG. 29 illustrates representation of the reference transfer function and an inverse of the reference transfer function to expedite computation;

FIG. 30 illustrates approximating the reference transfer function 750 as concatenated piecewise-linear segments or concatenated piecewise-polynomial segments.

FIG. 31 illustrates approximating an inverse of the reference transfer function 750 as concatenated piecewise-linear segments or concatenated piecewise-polynomial segments.

FIG. 32 illustrates organizing testing data of individual samples to ascertain homogeneity of the fluorescent material;

FIG. 33 illustrates a case of high variance of the contents of individual samples necessitating more thorough mixing of the constituents of the fluorescent material;

FIG. 34 illustrates a result of improved mixing of the fluorescence-material constituents where the homogeneity is improved but the mode of the distribution still differs significantly from the target mode;

FIG. 35 illustrates improved proximity of the mode of the distribution to the target mode;

FIG. 36 illustrates typical oscillatory approach toward the target mode (which is reduced in 0 the method of FIG. 11 and FIG. 12;

FIG. 37 illustrates a result of improved homogeneity of the fluorescent material and successful adjustment of the tuning-ingredient concentration for a single pivotal temperature;

FIG. 38 illustrates results of independent tuning for three pivotal temperatures of 100°, 500°, and 900°;

FIG. 39 illustrates an example of adjusting the concentration level of a type-1 tuning ingredient using successive additions of equal quantities of the tuning ingredient, in accordance with an embodiment of the present invention;

FIG. 40 illustrates an example of adjusting the concentration level of a type-2 tuning ingredient using successive additions of equal quantities of the tuning ingredient, in accordance with an embodiment of the present invention; and

FIG. 41 illustrates reuse of homogenized batches and corresponding decay-time measurements.

### TERMINOLOGY

Fluorescence lifetime: The term refers to the time period between the initial maximum value of the intensity of the signal and the instant at which the intensity decays to a value of (1/e) of the initial value, “e” being the Bernoulli-Euler number (˜2.71828).

Fluorescence decay-time: The terms fluorescence lifetime and fluorescence decay-time are used synonymously.

Transducer: The term refers to the conventional definition as a substance or a device that converts a first form of energy to a second form of energy.

Transfer function of a transducer: The term refers to a function that relates a measurable characteristic of the second form of energy to a measurable characteristic of the first form of energy over a domain of interest.

Fluorescent material: A fluorescent material as referenced in the present application is a specific transducer that receives both thermal energy and incident electromagnetic energy and emits electromagnetic energy at a wavelength longer than that of the incident electromagnetic energy.

Input measurable characteristics: The energy supplied to the above fluorescent material include incident electromagnetic energy and thermal energy. Measurable characteristics of the incident electromagnetic energy include intensity and wavelength. Measurable characteristics of the thermal energy include temperature.

Output measurable characteristics: The energy emitted from the above fluorescent material include radiated electromagnetic energy of a longer wavelength in comparison with the incident electromagnetic energy with measurable characteristics including intensity, wavelength, and fluorescence lifetime (decay-time).

Simple transfer function: A simple transfer function of the fluorescent material is defined as a relation between any measurable characteristic of received energy and any measurable characteristic of emitted energy. The measurable characteristics of the received energy include the incident intensity, the incident wavelength, and the temperature. The measurable characteristics of the emitted electromagnetic wave include intensity, wavelength, and fluorescence lifetime (decay-time). Thus, several simple transfer functions may be defined. In the present application, only the transfer function relating fluorescence lifetime to temperature is used.

Composite transfer function: A composite transfer function of the fluorescent material may relate any measurable characteristic of the emitted electromagnetic energy to two or more characteristics of the received energy (electromagnetic and thermal).

Pivotal points: To compare a transfer function of a current fluorescent material with the reference transfer function, the fluorescence lifetime is measured at selected pivotal temperatures; a pivotal temperature and a corresponding lifetime are together referenced as a pivotal point.

Observation points: While the fluorescent material is maintained at a selected pivotal temperature, measuring deviation of a current transfer function from the reference transfer function is based on measuring deviation at specified observation values and determining the mean value of the magnitudes (i.e., absolute values) of the deviations. An observation temperature and a corresponding fluorescence lifetime are, together, referenced as an observation point.

Compatibility: Two fluorescent materials are said to be compatible if they have congruent, or nearly congruent within an acceptable deviation measure, transfer functions.

Backward compatibility: A fluorescent material that undergoes a composition change from a previous version is said to be “backward compatible” if a transfer function of a current version and a respective transfer function of the previous version are congruent, or nearly congruent, within an acceptable deviation measure.

Deviation measure: To measure discrepancy between a transfer function of a currently formed fluorescence material and the reference transfer function, deviation values are measured at selected fluorescence temperatures and a mean value of the magnitudes of the deviations is used as a deviation measure.

Tuning ingredients: A tuning ingredient of a fluorescent material is any component the addition of which alters the fluorescence lifetime. The host material itself and/or a dopant are preferably tuning ingredients. According to the present invention, the filler is preferably inert.

Type-1 tuning ingredient: A tuning ingredient is said to be of type-1 if increasing its concentration increases the fluorescence lifetime (decay-time).

Type-2 tuning ingredient: A tuning ingredient is said to be of type-2 if increasing its concentration decreases the fluorescence lifetime (decay-time).

### REFERENCE NUMERALS

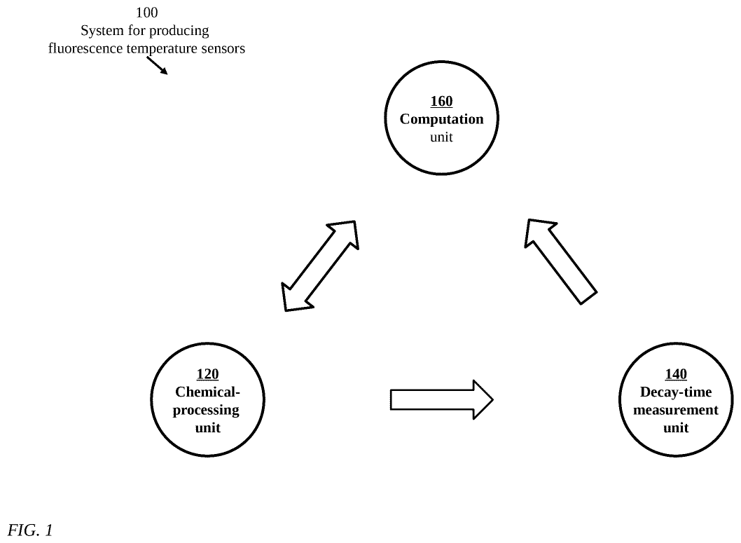

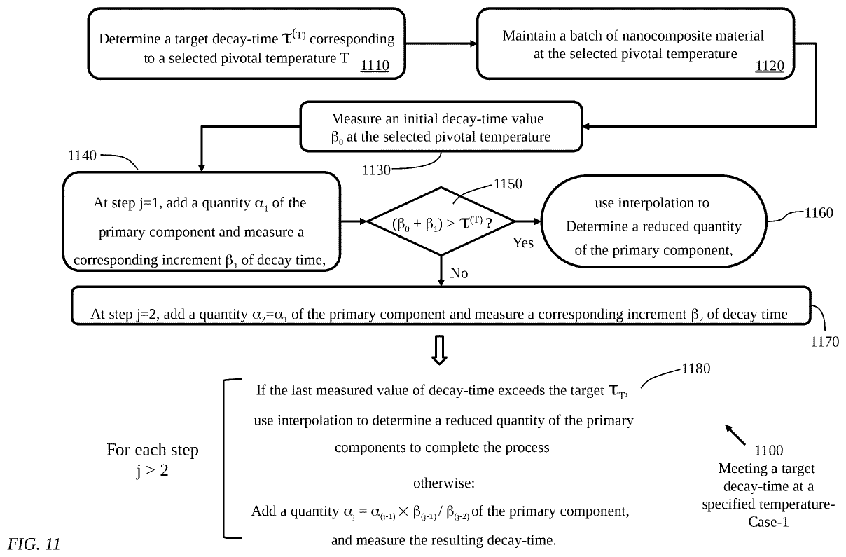

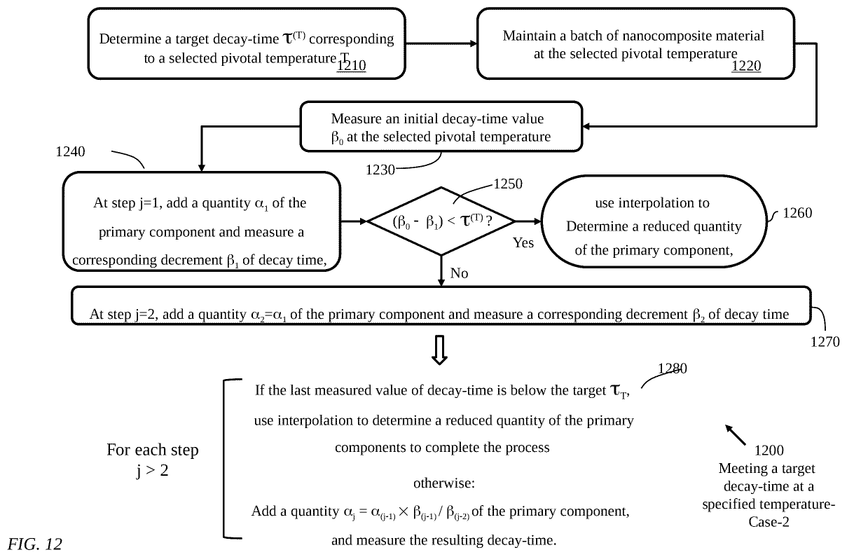

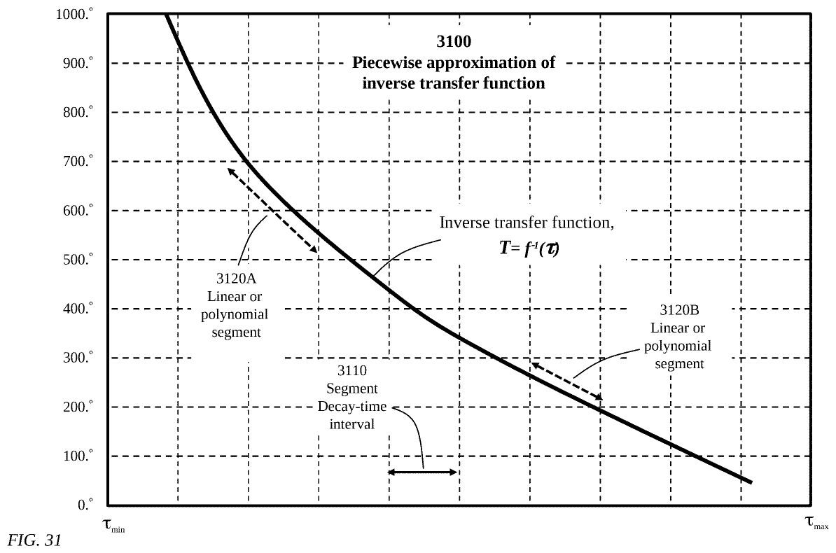

100: A system for producing fluorescence-based temperature sensors under compatibility constraints
120: Chemical-processing facility for forming batches of fluorescence material
140: An apparatus for measuring fluorescence lifetime (decay-time)
160: A computation module for determining required adjustments of constituents of the fluorescence material to satisfy a specified fluorescence lifetime versus temperature relationship
200: A system similar to the system of FIG. 1 but using a central controller
250: A central controller
300: Composition of fluorescence material for use in producing temperature sensors
320: Phosphor powder comprising a host and a dopant
321: A host component
322: A dopant component
323: A filler
340: Fluorescent material comprising the phosphor powder and the filler
400: Constraints under which the temperature sensors are produced
410: Monotonic variation with temperature of effect of tuning ingredient
412: Adherence to specified fluorescence lifetime variation with temperature
414: Using adjusted fluorescence material to produce temperature sensors
500: Known fluorescence properties that enable temperature measurement
510: Normalised fluorescence-emission-level decay as a function of time with the fluorescence material maintained at a first temperature T₁
511: Normalised fluorescence-emission-level decay as a function of time with the fluorescence material maintained at a second temperature T₂>T₁
512: Normalised fluorescence-emission-level decay as a function of time with the fluorescence material maintained at a third temperature T₃>T₂
600: Control of the fluorescence properties to enable backward compatibility of a transfer function of currently produced temperature sensors with a reference transfer function
610: Normalised fluorescence-emission-level decay as a function of time, having a fluorescence lifetime of τ₂
612: Normalised fluorescence-emission-level decay as a function of time, having a fluorescence lifetime >τ₂ due to increasing concentration of a type-1 tuning ingredient
614: Normalised fluorescence-emission-level decay as a function of time, having a fluorescence lifetime <τ₂ due to increasing concentration of a type-2 tuning ingredient
640: Controlled fluorescence lifetime values according to concentration levels of tuning ingredients of the fluorescence material
700: Main constraint that governs production of the temperature sensors
750: A reference monotone decreasing function of fluorescence lifetime with respect to temperature of a fluorescence material (i.e., a reference transfer function)
800: A one-to-one correspondence of a measured fluorescence lifetime to temperature of a respective fluorescence material produced to adhere to the fluorescence lifetime versus temperature 750
810: A measured fluorescence lifetime τ₁₀₀ correspondence to a sensor temperature of 100° (Celsius)
850: A measured fluorescence lifetime τ₅₀₀ correspondence to a sensor temperature of 500° (Celsius), τ₁₀₀>τ₅₀₀
900: Adjusting components concentration to reach a target fluorescence lifetime
910: initial value of fluorescence lifetime that is less than a target fluorescence lifetime
912: increasing fluorescence lifetime at a specific temperature) (˜350° Celsius
920: Target fluorescence lifetime
930: initial value of fluorescence lifetime that is greater than the target fluorescence lifetime
932: Decreasing fluorescence lifetime at a specific temperature) (˜350° Celsius
1000: Processes of adjusting concentration level of a tuning ingredient of a fluorescence material based on measurements of fluorescence lifetime
1100: A flowchart of a method of adaptively adjusting the concentration level of a type-1 tuning ingredient of a batch of the fluorescent material to yield a decay-time closely equal to a target decay-time
1200: A flowchart of a method of adaptively adjusting the concentration level of a type-2 tuning ingredient of a batch of the fluorescent material to yield a decay-time closely equal to a target decay-time
1300: Application of the method of FIG. 11 for a case where the target fluorescence lifetime is less than a current lifetime measurement
1400: Application of the method of FIG. 12 for a case where the target fluorescence lifetime is less than a current lifetime measurement
1500: A table illustrating variation of fluorescence lifetime with both the temperature of a specific fluorescence material and concentration level of tuning ingredients of the specific fluorescence material; the table is used to define a major objective the present invention which is find a concentration level that leads to a monotone decreasing function of fluorescence lifetime with respect to temperature that closely approximates the reference function 750, hence enabling production backward compatibility
1600: Use of a set of observation temperatures for estimating proximity of the attained fluorescence lifetime versus temperature relationship to the reference transfer function 750, based on a criterion for determining a measure of deviation of fluorescence lifetime values from corresponding reference values
1620: A selected pivotal point
1640: One observation point of a set of observation points
1650: An attained transfer function due to a concentration level of a tuning ingredient that corresponds to intersection at pivotal point 1620
1700: Use of a set of pivotal points and a set of observation points for estimating proximity of an attained relationship of fluorescence lifetime versus temperature to the reference function 750
1720: Pivotal points
1800: Fluorescence lifetime variation with temperature for two independent cases where the fluorescence material is adaptively adjusted to yield fluorescence lifetime values that are precisely close to corresponding reference values of the reference function 750
1810: First pivotal point
1820: Second pivotal point
1812: Transfer function corresponding to intersection at the first pivotal point
1822: Transfer function corresponding to intersection at the second pivotal point
1900: Selection of pivotal points and observation points for different temperature ranges
1920: Pivotal points for a temperature range 250° to 450° Celsius
1925: Observation points for the temperature range 250° to 450° Celsius
1930: Pivotal points for a temperature range 600° to 800° Celsius
1935: Observation points for the temperature range 600° to 800° Celsius
2000: A method of determining a concentration level of tuning ingredients of a fluorescent material to yield fluorescence lifetime values that closely approximates corresponding reference values
2100: Individual results indicating deviations corresponding to the pivotal points to be used to determine a concentration level yielding the minimum deviation
2120: For each pivotal point, a concentration level and a resulting deviation indicator 2140 are recorded to enable interpolation to find an optimal concentration level
1240: deviation indicators
2125: Optimal concentration level
2145: Minimum deviation.
2200: formation and adjustments of batches of fluorescence material for production of backward compatible temperature sensors
2220: A single batch
2240: Independently produced batches
2300: Extracted number of samples of fluorescence material to be individually tested for compatibility with corresponding reference values, the number need be large enough to enable statistically meaningful analysis
2400: Successive testing of individual samples of a same batch
2410: A set of samples
2412: A single sample being tested
2420: Incident light
2430: Emitted electromagnetic wave (light)
2440: Instrument for measuring decay-time
2450: Storage medium holding measurements
2500: Discretization of the reference function 750
2600: Precision discrete approximation of the reference function 750
2620 Records (bins) for selected narrow temperature intervals (1°—wide intervals)
2700: Temperature-range-dependent discrete approximation of the reference function 750
2710: Temperature-intervals for a first range of temperatures
2720: Temperature-intervals for a second range of temperatures
2730: Temperature-intervals for a third range of temperatures
2800: Process of ensuring homogeneity of the fluorescence material based on testing individual samples
2900: Representation of the transfer function of fluorescence lifetime versus temperature to expedite computation
3000: Approximation of the reference transfer function 750 as concatenated piecewise-linear segments or concatenated piecewise-polynomial segments
3010: A temperature span of a segment of the reference transfer function
3020: Segments of the transfer function
3100: Approximation of an inverse of the reference transfer function 750 as concatenated piecewise-linear segments or concatenated piecewise-polynomial segments
3110: Duration of a segment of the inverse transfer function
3120: Segments of the inverse transfer function 750
3200: Sorting decay-time values of individual samples to ascertain homogeneity of the fluorescent material and determine if any adjustment of the fluorescent material is needed
3210: Samples extracted from a batch of the fluorescent material
3220: Incident electromagnetic wave (such as light)
3230: Emitted electromagnetic energy
3240: Measuring decay-time
3250: Process of determining a temperature corresponding to a measured delay-time (FIG. 31) and increasing count of a respective bin
3260: Bins for sorting inverse-transfer-function values of measured decay-times
3264: Central temperature of measurements associated with a bin. For example, a decay-time measurement that has an inverse-transfer-function value between 498° and 502° increases a count of a bin of central temperature 500°
3300: A case of high variance of the contents of individual samples necessitating more thorough mixing of the contents of the fluorescent material
3400: A result of improved mixing of the fluorescence-material contents where the homogeneity is improved but the mode of the distribution still differs significantly from the target mode, thus requiring modifying contents of the fluorescent material
3500: Improved proximity of the mode of the distribution to the target mode
3600: Typical oscillatory approach toward the target mode (which is reduced in the method of FIG. 11 and FIG. 12)
3700: A result of improved homogeneity of the fluorescent material and successful adjustment of the tuning-component concentration for a single pivotal temperature
3800: Results of independent tuning for three pivotal temperatures of 100°, 500°, and 900°
3810: Result of adjusting the batch content at a pivotal temperature of 100°
3820: Result of adjusting the batch content at a pivotal temperature of 500°
3830: Result of adjusting the batch content at a pivotal temperature of 900°
3900: Adjusting the concentration level of a type-1 tuning ingredient using successive additions of equal quantities of the tuning ingredient
4000: Adjusting the concentration level of a type-21 tuning ingredient using successive additions of equal quantities of the tuning ingredient
4100: Reuse of homogenized batches and corresponding decay-time measurements
4101: A pivotal temperature T₁
4102: A pivotal temperature T₂>T₁
4103: A pivotal temperature T₃>T₂
4104: A pivotal temperature T₄>T₃
4110: A set of samples from a batch of fluorescent material with a tuning ingredient of concentration Q₁, held at a pivotal temperature T₁ to measure a respective decay-time
4120: A set of samples from a batch of fluorescent material with a tuning ingredient of concentration Q₂, Q₂>Q₁, held at the pivotal temperature T₁ to measure a respective decay-time
4130: A set of samples from a batch of fluorescent material with a tuning ingredient of concentration Q₃, Q₃>Q₂, successively held at four pivotal temperatures T₁, T₂, T₃, and T₄, to measure respective decay-times, T₁<T₂<T₃<T₄
4140: A set of samples from a batch of fluorescent material with a tuning ingredient of concentration Q₄, Q₄>Q₃, successively held the four pivotal temperatures T₁, T₂, T₃, and T₄, to measure respective decay-times
4150: A set of samples from a batch of fluorescent material with a tuning ingredient of concentration Q₅, Q₅>Q₄, successively held the four pivotal temperatures T₁, T₂, T₃, and T₄, to measure respective decay-times
4191: A target decay-time τ₁ at temperature T₁
4192: A target decay-time τ₂ at temperature T₂, τ₂<τ₁
4193: A target decay-time τ₃ at temperature T₃, τ₃<τ₂
4194: A target decay-time τ₄ at temperature T₄, τ₄<τ₃

### DETAILED DESCRIPTION OF EMBODIMENTS

FIG. 1 illustrates a system 100 for producing fluorescence-based temperature sensors under transfer-function constraints. The system comprises three basic units, a chemical-processing unit, 120, a fluorescence-lifetime measurement unit 140, and a computation unit 160.

Unit 120 comprises equipment for forming batches of fluorescent material comprising a host substance of a specified type and particle size, a dopant of a specified type and particle size, and a filler of a specified type. Concentration levels of the components are adaptively determined in computation unit 160 based on measurements received from unit 140. The equipment further enables extracting and solidifying a set of samples from a selected batch and holding the set of samples at different temperatures within a predefined temperature range according to instructions from the computation unit 160.

Unit 140 comprises a microprocessor, a light source, and a light detector (not illustrated), and is configured to subject each sample of a set of samples to incident light from the light source and measure a fluorescence lifetime (decay-time).

Unit 160 comprises a respective processor, a memory device holding software instructions, and a memory device holding intermediate data. The unit is configured to determine required adjustments of the fluorescence material to attain a fluorescence lifetime versus temperature relationship that is congruent, or nearly congruent, to a reference transfer function.

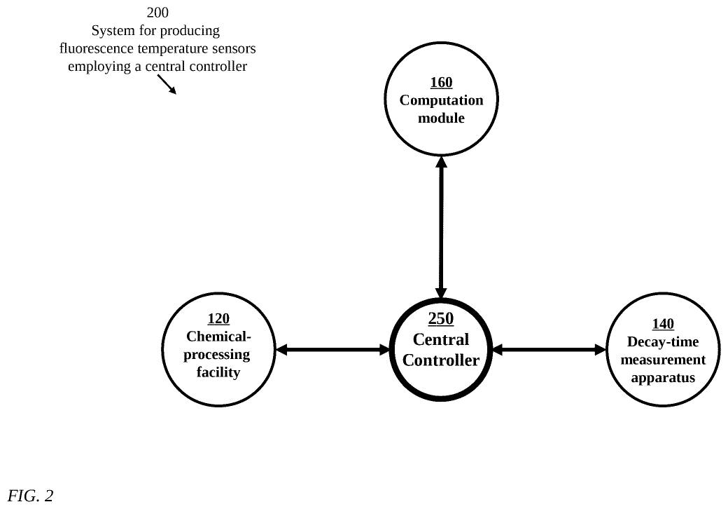

FIG. 2 illustrates a variation 200 of the system of FIG. 1 using a central controller 250 for orchestrating the interactive processes performed at units 120, 140, and 160.

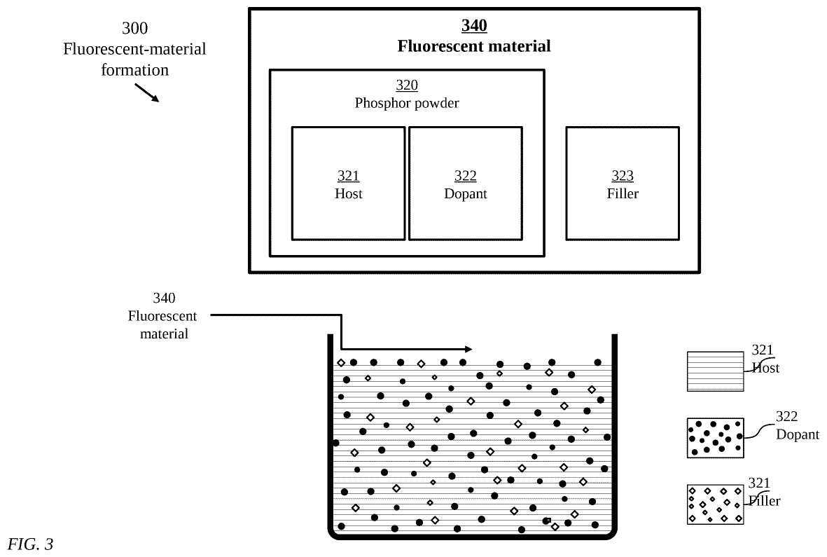

FIG. 3 illustrates formation 300 of a fluorescence material 340 for use in producing temperature sensors in the system of FIG. 1 or FIG. 2. The fluorescent material comprises a host substance 321, a dopant 322, and a filler 323. The combination of the host and dopant, referenced as a phosphor powder 320, influences the transfer function of the fluorescent material. The filler 323 is preferably inert and used mainly for structural stability of the fluorescent material 340.

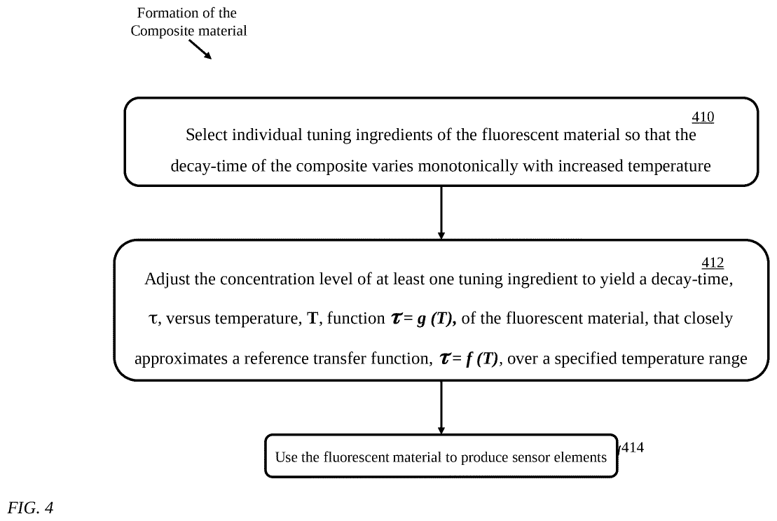

FIG. 4 illustrates requisite constraints 400 under which the temperature sensors are produced. A first constraint, 410, is that each tuning ingredient cause monotonic variation of fluorescence lifetime with temperature within a specified temperature range. A second constraint, 412, is adherence to the reference transfer function (relating fluorescence lifetime variation to temperature variation). Upon adjusting the fluorescent material accordingly, the adjust material are used to produce temperature sensors (reference 414).

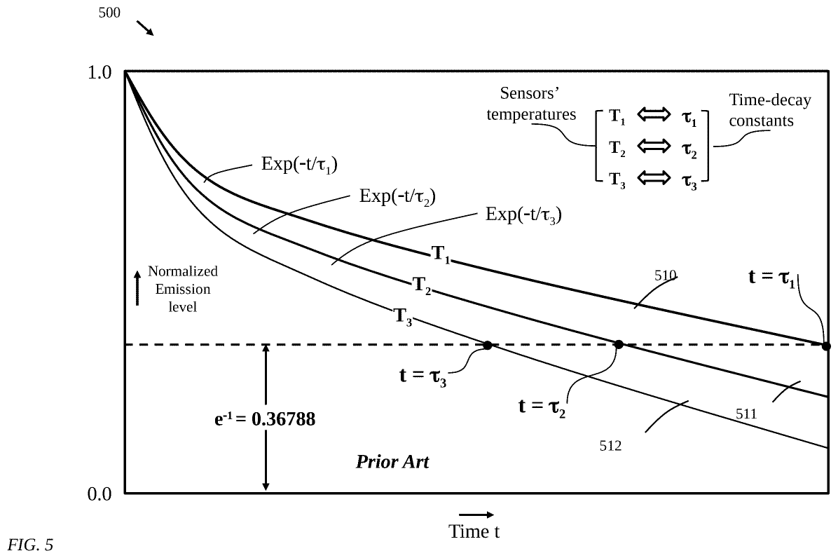

FIG. 5 illustrates a known fluorescence property 500. The figure illustrates three normalised fluorescence-emission-level decay as a function of time, 510, 511, and 512, with the fluorescence material maintained at temperatures T₁, T₂, and T₃, respectively, where T₁<T₂<T₃. The corresponding fluorescence lifetimes (where the intensity is 1/e of the initial maximum intensity) are τ₁, τ₂, and τ₃, where τ₁>τ_{2,}>τ₃. This fluorescence property enables temperature measurement based on measured fluorescence lifetime.

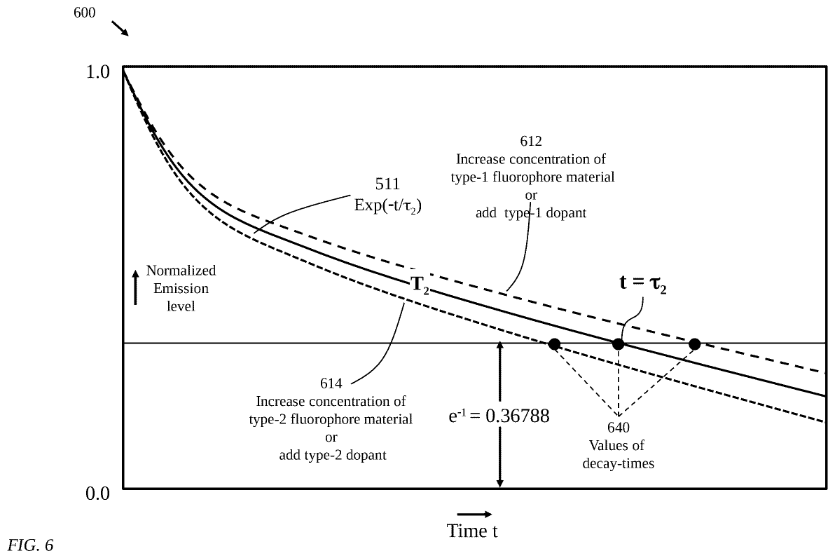

FIG. 6 illustrates an example 600 of control of the fluorescence properties of FIG. 5 to enable backward compatibility of a currently produced fluorescent material with a previously produced fluorescent material (possibly using different ingredients). The current fluorescence material may be adjusted to yield a transfer function that closely approximates the reference transfer function.

With the fluorescence material held at a temperature T₂ (reference 511, FIG. 5), increasing concentration of a type-1 tuning ingredient results in a normalised fluorescence-emission-intensity decay as a function 612 of time, which has a fluorescence lifetime exceeding τ₂.

With the fluorescence material held at a temperature T₂ (reference 511, FIG. 5), increasing concentration of a type-2 tuning ingredient results in a normalised fluorescence-emission-intensity decay as a function 614 of time, which has a fluorescence lifetime below τ₂. Thus, fluorescence lifetime values 640 depend on types and concentration levels of tuning ingredients of the fluorescence material.

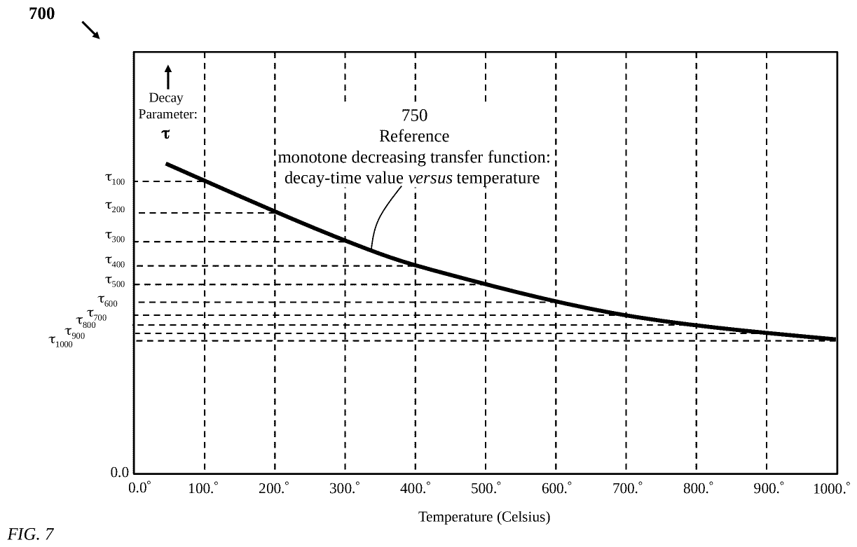

FIG. 7 illustrates an exemplary reference transfer function 750 which governs production of temperature sensors. Transfer function 750 is a monotone decreasing function of fluorescence lifetime with respect to temperature of a fluorescence material.

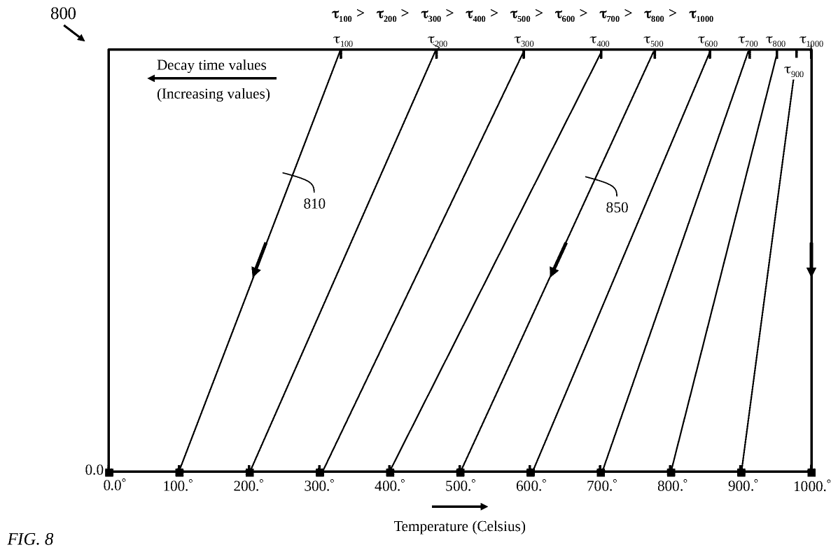

FIG. 8 illustrates a one-to-one correspondence 800 of a measured fluorescence lifetime to temperature of a respective fluorescence material produced to adhere to reference transfer function 750. A measured fluorescence lifetime τ₁₀₀ corresponds to a sensor temperature of 100° Celsius (reference 810). A measured fluorescence lifetime τ₅₀₀ corresponds to a sensor temperature of 500° Celsius (reference 850); τ₅₀₀<τ₁₀₀.

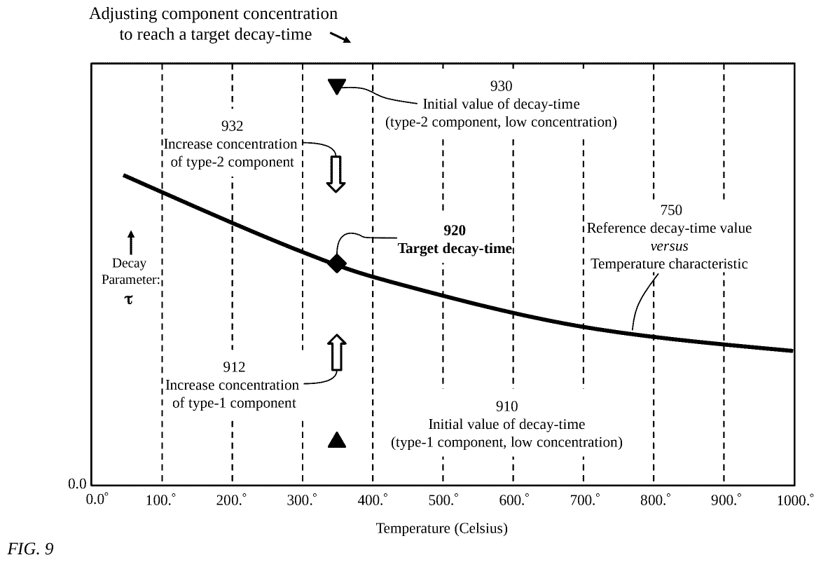

FIG. 9 illustrates a process 900 of adjusting components concentration to reach a target fluorescence lifetime. The fluorescence lifetime at a specific temperature of a fluorescence material may be increased or decreased according to types of the tuning ingredients of the fluorescence material.

If, at a specific temperature (in this example (≈350° Celsius), an initial value 910 of fluorescence lifetime is less than a target fluorescence lifetime 920, increasing concentration of a type-1 tuning ingredient (reference 912) can increase the fluorescence lifetime to approach the reference value 920. If, at the specific temperature, an initial value 930 of fluorescence lifetime is greater than the target fluorescence lifetime 920, increasing concentration of a type-2 tuning ingredient (reference 932) can decrease the fluorescence lifetime to approach the reference value 920.

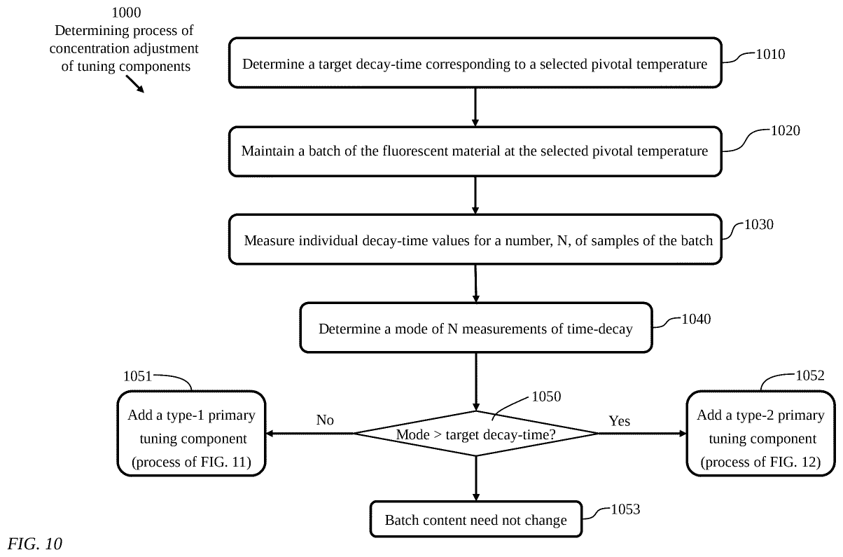

FIG. 10 illustrates processes 1000 of adjusting concentration level of a tuning ingredient of a fluorescence material based on measurements of fluorescence lifetime. Process 1010 determines a target fluorescence lifetime corresponding to a selected pivotal temperature. Process 1020 maintains a batch of a fluorescent material at the selected pivotal temperature. Process 1030 measures individual fluorescence lifetimes for a number, N, of samples of the batch. The number N is selected to render statistical analysis of measurements meaningful. Process 1040 determines a mode of N measurements of florescence lifetime. Process 1050 branches to:
process 1051, which adds a type-1 tuning ingredient, if the mode is less than a target value determined from the reference transfer function 750;
process 1052 which adds a type-2 tuning ingredient, if the mode is greater than the target value;
or
a no-action state 1053 if the magnitude of the difference between the mode and the target fluorescence lifetime is less than a predetermined tolerance.

FIG. 11 is a flowchart 1100 of a method of adaptively adjusting the concentration level of a type-1 tuning ingredient of a batch of the fluorescent material to yield a decay-time closely equal to a target decay-time τ^{(T)} at a specified pivot temperature T. τ^{(T)} is determined from the reference transfer function 750. The method is implemented as software instructions stored in a memory device of the computation unit 160.

Process 1110 determines the decay-time target τ^{(T)} corresponding to a selected pivotal temperature T. Process 1120 maintains samples of a batch of the fluorescent material at the selected pivotal temperature. Process 1130 measures an initial decay-time value β₀ at the selected pivotal temperature T, (β₀<τ^{(T)}). Process 1140 (step j=1) adds a quantity α₁ of the tuning ingredient and measures a corresponding decay-time from which a decay-time increment β₁ (due to the addition of the quantity α₁) is determined. Process 1150 compares the current value of decay-time τ₁ to the decay-time target τ^{(T)}; τ₁=(β₀+β₁).

If the current decay-time is larger than the target τ^{(T)}, process 1160 uses interpolation to determine the appropriate quantity of tuning ingredient needed to reach the target τ^{(T)}. If the current decay-time τ₁ is equal to or within acceptable deviation from, the target decay-time τ^{(T)}, the current level of concentration of the tuning ingredient is acceptable.

If the current decay-time τ₁ is less than the target τ^{(T)}, process 1170 (step j=2) adds a quantity α₂=α₁ of the tuning ingredient and measures a corresponding decay-time τ₂ from which a decay-time increment β₂ (due to the added quantity α₂) is determined. Recursive process 1180 is then executed.

At the end of each step j, j>2, the difference, δ, between the attained decay-time τⱼ and the target decay-time τ^{(T)} is determined as δ=(τ^{(T)}−τⱼ). The value of δ determines a subsequent action:
(1) If the magnitude of δ (i.e., |δ|) relevant to the target τ^{(T)}, i.e., (|δ|/τ^{(T)}) is less than a predefined tolerance ε, 0.0<ε<<1.0, (ε=0.001, for example), the target decay-time is considered to be reached and no further batch adjustment is needed;
(2) If δ≥βⱼ, at the next step (j+1), a quantity αⱼ₊₁ of the tuning ingredient is added;
(3) If 0.0<δ<βⱼ, a quantity, Δ, of the tuning ingredient to the batch, determined as:

$$Δ = δ \times {α}_{j} / {β}_{j} ;$$

and
(4) If, δ<0.0, i.e., the total quantity of dopant material exceeds the needed amount, the current quantity of tuning ingredient Q=(α1+α2+ . . . αj) of tuning ingredient would be reduced to (Q+(δ×αⱼ/βⱼ)) to just reach the target decay-time τ^{(T)}.

For j>2, where the decay-time is less than the target value, a quantity αⱼ of the tuning ingredient is added to the batch and a corresponding decay-time τⱼ is measured, from which decay-time increment βⱼ is determined. The quantity αⱼ is determined as:

$${α}_{j} = {α}_{( j - 1 )} \times ( {β}_{( j - 1 )} / {β}_{( j - 2 )} ) , j > 2 .$$

FIG. 12 is a flowchart 1200 of a method of adaptively adjusting the concentration level of a type-2 tuning ingredient of a batch of the fluorescent material to yield a decay-time closely equal to a target decay-time τ^{(T)} at a specified pivot temperature T. τ^{(T)} is determined from the reference transfer function 750. The method is implemented as software instructions stored in a memory device of the computation unit 160.

Process 1210 determines the decay-time target τ^{(T)} corresponding to a selected pivotal temperature T. Process 1220 maintains samples of a batch of the fluorescent material at the selected pivotal temperature. Process 1230 measures an initial decay-time value β₀ at the selected pivotal temperature T, (β₀>τ^{(T)}). Process 1240 (step j=1) adds a quantity α₁ of the tuning ingredient and measures a corresponding decay-time τ₁ from which a decay-time decrement β₁ (due to the addition of the quantity α₁) is determined. Process 1250 compares the current value of decay-time τ₁ to the decay-time target; τ₁=(β₀−β₁).

If the current decay-time τ₁, τ₁=(β₀−β₁), is below the target τ^{(T)}, process 1260 uses interpolation to determine the appropriate quantity of tuning ingredient needed to reach the target τ^{(T)}. If the current decay-time τ₁ is equal to or within acceptable deviation from, the target decay-time τ^{(T)}, the current level of concentration of the tuning ingredient is acceptable.

If the current decay-time τ₁ is larger than the target τ^{(T)}, process 1270 (step j=2) adds a quantity α₂=α₁ of the tuning ingredient and measures a corresponding decay-time τ₂ from which a decay-time decrement β₂ (due to the added quantity α₂) is determined. Recursive process 1280 is then executed.

At the end of each step j, j>2, the difference, δ, between the attained decay-time τⱼ and the target decay-time τ^{(T)} is determined as δ=(τⱼ−τ^{(T)}). The value of δ determines a subsequent action:
(i) If the magnitude of δ (i.e., |δ|) relevant to the target τ^{(T)}, i.e., (|δ|/τ^{(T)}) is less than a predefined tolerance ε, 0.0<ε<<1.0, (ε=0.001, for example), the target decay-time is considered to be reached and no further batch adjustment is needed;
(ii) If δ≥βⱼ, at the next step (j+1), a quantity αⱼ₊₁ of the tuning ingredient is added;
(iii) If 0.0<δ<βⱼ, a quantity, Δ, of the tuning ingredient to the batch, determined as:

$$Δ = δ \times {α}_{j} / {β}_{j} ;$$

and
(iv) If, δ<0.0, i.e., the total quantity of dopant material exceeds the needed amount, the current quantity of tuning ingredient Q=(α1+α2+ . . . αj) of tuning ingredient would be reduced to (Q+(δ×αⱼ/βⱼ)) to just reach the target decay-time τ^{(T)}.

For j>2, where the decay-time is larger than the target value, a quantity αⱼ of the tuning ingredient is added to the batch and a corresponding decay-time τⱼ is measured, from which decay-time decrement βⱼ is determined. The quantity αⱼ is determined as:

$${α}_{j} = {α}_{( j - 1 )} \times ( {β}_{( j - 1 )} / {β}_{( j - 2 )} ) , j > 2 .$$

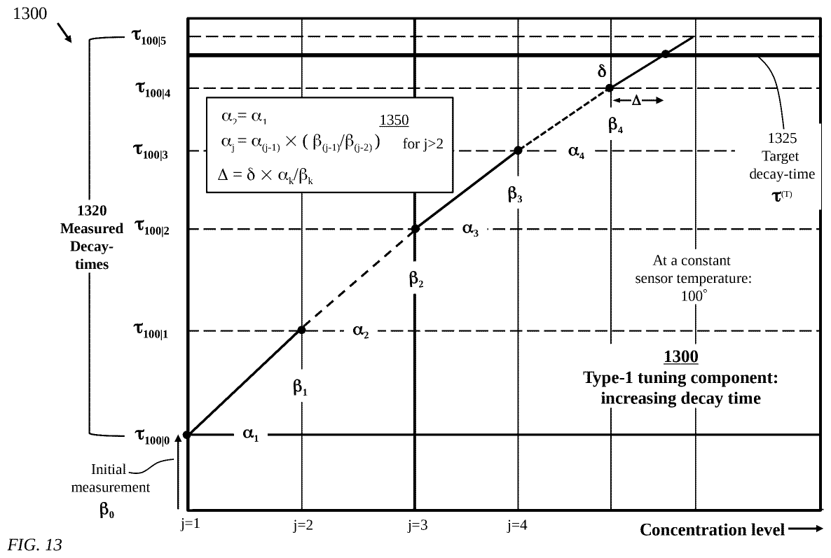

FIG. 13 illustrates application of the method of FIG. 11 for a case where the target fluorescence lifetime is less than a current lifetime measurement.

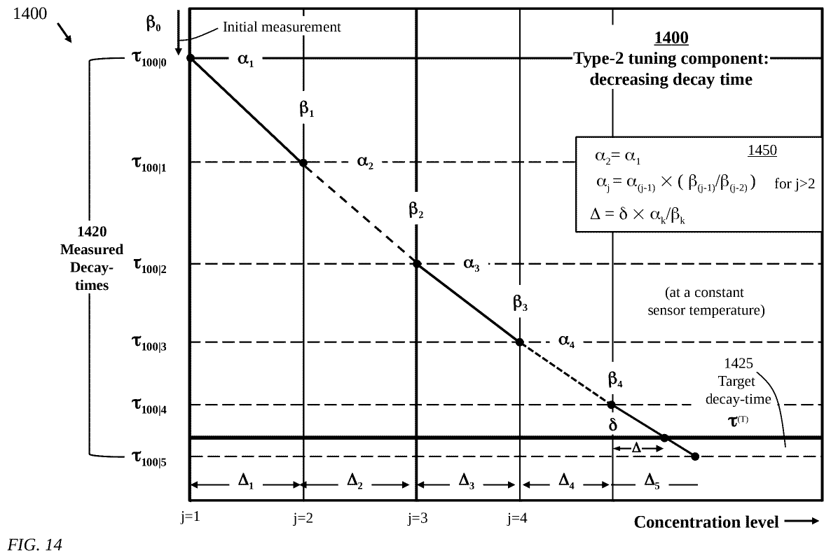

FIG. 14 illustrates application of the method of FIG. 12 for a case where the target fluorescence lifetime is less than a current lifetime measurement.

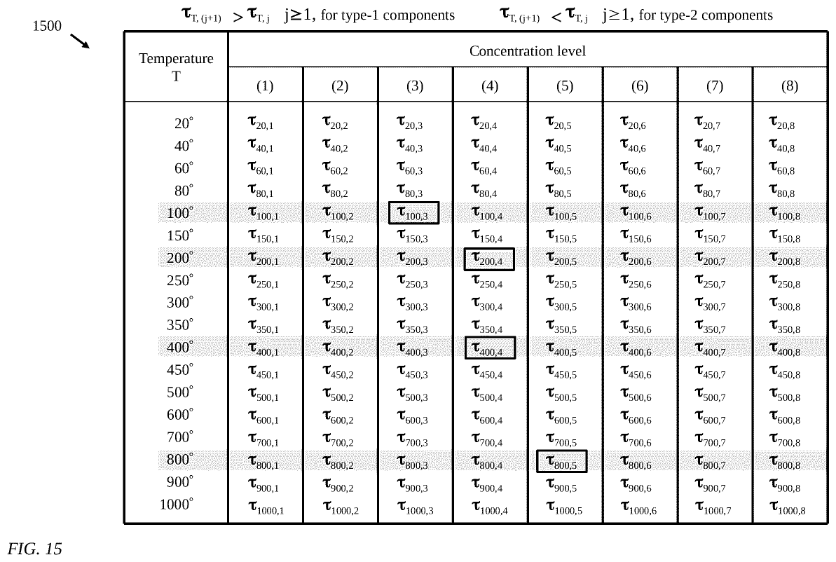

FIG. 15 is a table 1500 illustrating variation of fluorescence lifetime with both the temperature of a specific fluorescence material and concentration level of the tuning ingredient of the specific fluorescence material. The table is not necessarily fully constructed but is used to define a major objective the present invention which is to find a concentration level that leads to a monotone decreasing transfer function of fluorescence lifetime (decay-time) versus temperature that closely approximates the reference function 750, hence enabling production backward compatibility.

The temperature of the fluorescence samples is varied between 20° to 1000°Celsius. The concentration level of the tuning ingredient is set at eight levels, indexed as (1) to (8), in an ascending order. A fluorescence lifetime (decay-time) corresponding to a temperature T and concentration level L is denoted τ_{T,,L} To determine the deviation of a transfer function corresponding to a specific concentration level, L, the values τ_{T,,L} for all listed values of T (leftmost column of FIG. 15) would be compared with corresponding values determined from the reference transfer function 750 and the mean value of the magnitudes of difference is used as an indicator of proximity of the measured transfer function to the reference transfer function 750.

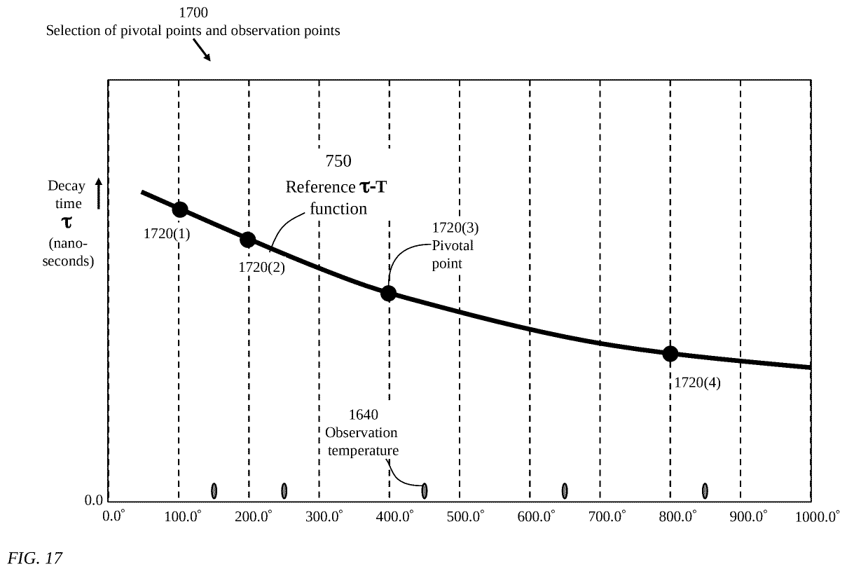

Since it is impractical to conduct such an experiment for numerous values of L, a smaller number of pivotal temperatures (FIG. 17) are selected and for each pivotal temperature a concentration level that yields a decay-time that is close to a corresponding reference value is determined as illustrated in FIG. 11 to FIG. 14.

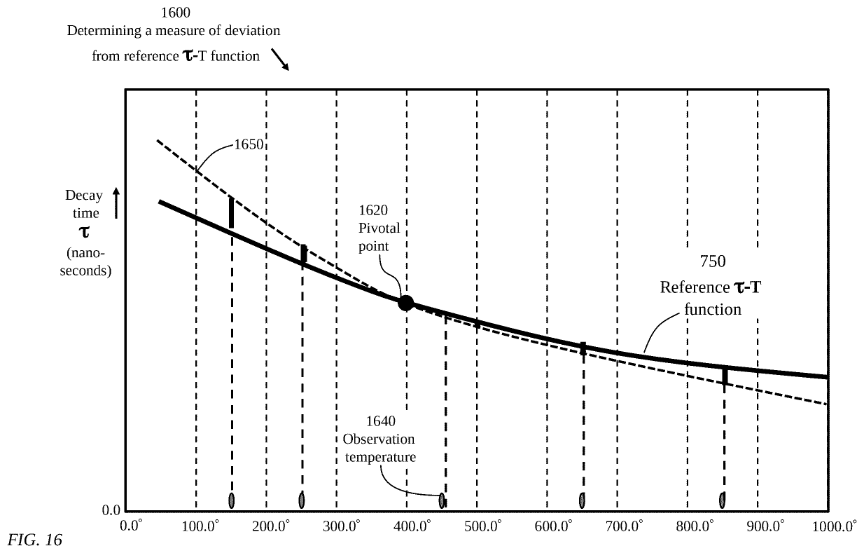

FIG. 16 illustrates an example 1600 of determining a measure of deviation of a transfer function, corresponding to a single adjusted pivotal point, from the reference transfer function. A set of observation temperatures is use for estimating proximity of the attained fluorescence lifetime versus temperature relationship to the reference function 750, based on a measure of deviation of fluorescence lifetime values from corresponding reference values

For a single selected pivotal point 1620, the fluorescent material is adjusted to yield a decay-time that closely approximates a corresponding reference value (FIG. 11 to FIG. 14). The resulting transfer function 1650 is, so far, unknown but a number of points, corresponding to a set of observation temperatures 1640, of transfer function 1650 can be measured. The mean value of the magnitudes of the deviations (i.e., the absolute values of the deviations) is used as a measure of deviation.

FIG. 17 illustrates selection 1700 of a set of pivotal points and a set of observation points for deriving a transfer function and estimating proximity of the derived transfer function (of fluorescence lifetime versus temperature) from the reference function 750.

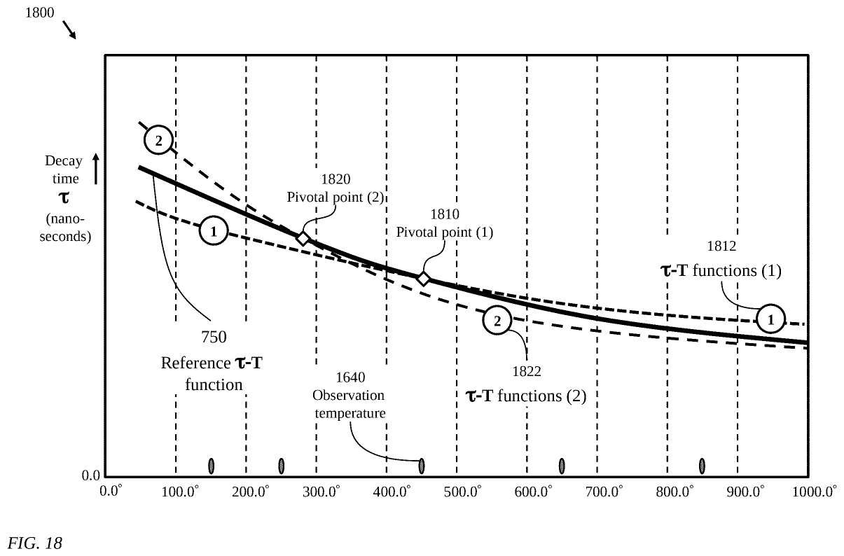

FIG. 18 illustrates a case 1800 of transfer functions for two independent cases. At a first pivotal temperature, the fluorescent material of a first batch is adjusted to yield a decay-time τ⁽¹⁾ that equals the target value of the reference transfer function 750. The corresponding transfer function 1812 intersects the reference transfer function 750 at pivotal point 1810 which corresponds to τ⁽¹⁾. For each of the observation temperatures 1640, the decay-time is measured and a deviation indicator is determined as the mean value of magnitudes of deviation as described above with reference to FIG. 16.

At a second pivotal temperature the fluorescent material of a second batch is adjusted to yield a decay-time τ⁽²⁾ that equals the target value of the reference transfer function 750. The corresponding transfer function 1822 intersects the reference transfer function 750 at pivotal point 1820 which corresponds to τ⁽²⁾. For each of the observation temperatures 1640, the decay-time is measured and a deviation indicator is determined. The batch corresponding to the lower deviation indicator is more suitable for producing temperature sensors.

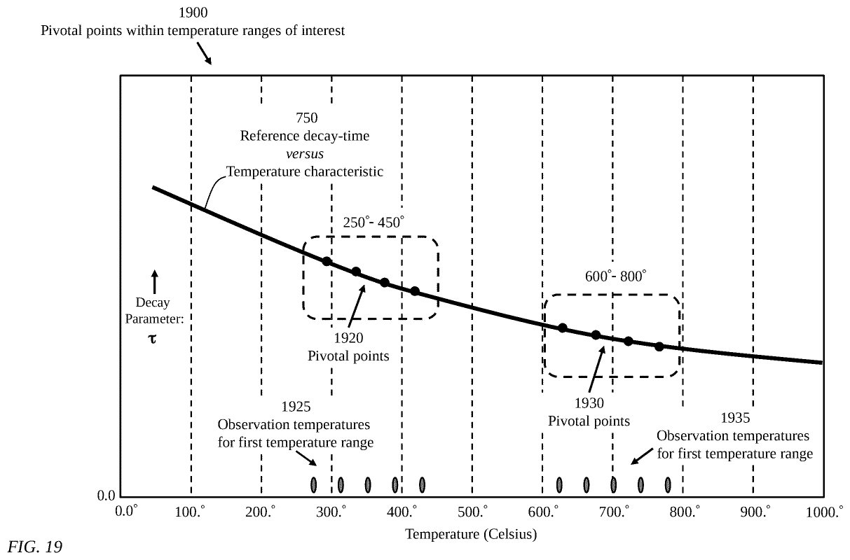

FIG. 19 illustrates a case 1900 where temperature sensors are produced for narrower ranges of temperatures. Pivotal points and observation points are selected for each temperature range. Pivotal points 1920, and observation points 1925, are used for a temperature range 250° to 450° Celsius. Pivotal points 1930, and observation points 1935, are used for a temperature range 600° to 800° Celsius.

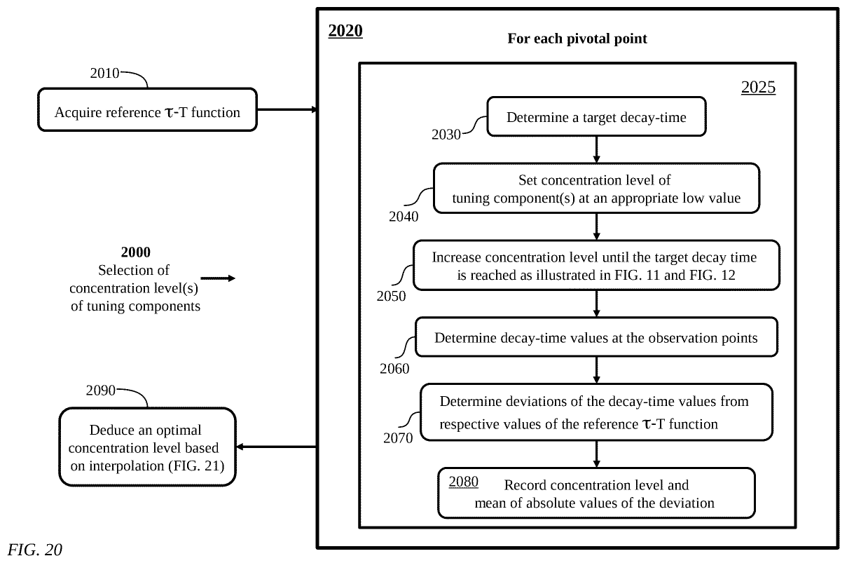

FIG. 20 illustrates a method 2000 of determining a concentration level of a tuning ingredient of a fluorescent material to yield fluorescence lifetime values that closely approximates corresponding reference values.

Process 2010 acquires a reference transfer function 750 for a temperature range and selects a number of pivotal temperatures and a number of observation points (FIG. 17).

Process 2020 selects one of the pivotal temperatures.

Processes 2025, which includes processes 2030 to 2080, determine a concentration level that results in a delay-time precisely approximating a corresponding reference value and determine an indicator of deviation of a corresponding transfer function from the reference transfer function 750. Process 2030 determines a target decay-time corresponding to the pivotal temperature under consideration. Process 2040 selects an initial low concentration level. Process 2050 increases the concentration level adaptively until the target decay-time is reached as illustrated in FIG, 11 and FIG. 12. Process 2060 determines decay-time values corresponding to the observation temperatures. Process 2070 determines deviations of the determined from corresponding reference values. Process 2080 determines a deviation measure, for the pivotal temperature under consideration, based on a mean value of absolute values of deviations corresponding to the observation points.

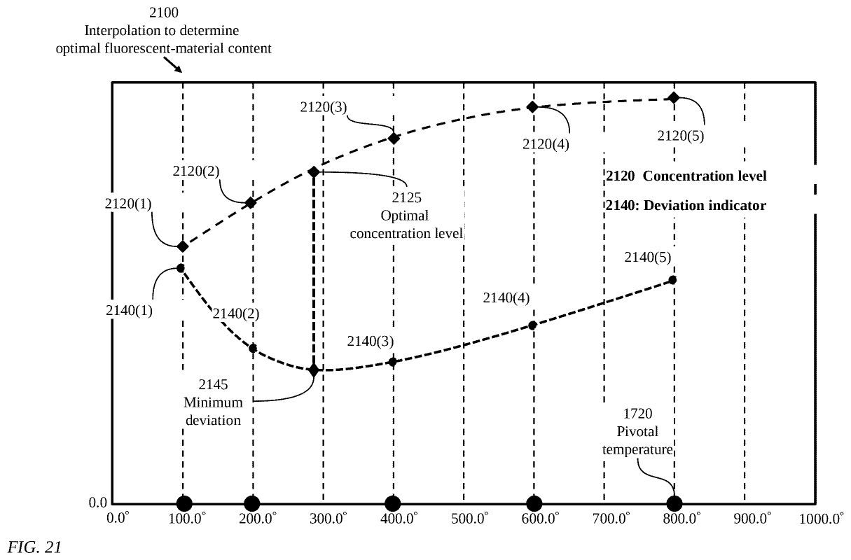

Process 2090 deduces an optimal concentration level corresponding to least deviation based on interpolating the results corresponding to the pivotal temperatures (FIG. 21).

FIG. 21 illustrates interpolation 2100 of individual results corresponding to the pivotal points to determine a concentration level yielding the minimum deviation over the temperature range of interest. The method of FIG. 20 determines deviation indicators 2140(1) to 2140(5), corresponding the five pivotal points. For each pivotal point, a concentration level 2120 and a resulting deviation indicator 2140 are recorded. Interpolating the deviation-versus-temperature data, 2140(1) to 2140(5), an optimal concentration level and a corresponding intermediate temperature can be determined. Interpolating the concentration-versus-temperature data, 2120(1) to 2120(5), a concentration level corresponding to the intermediate temperature can be determined.

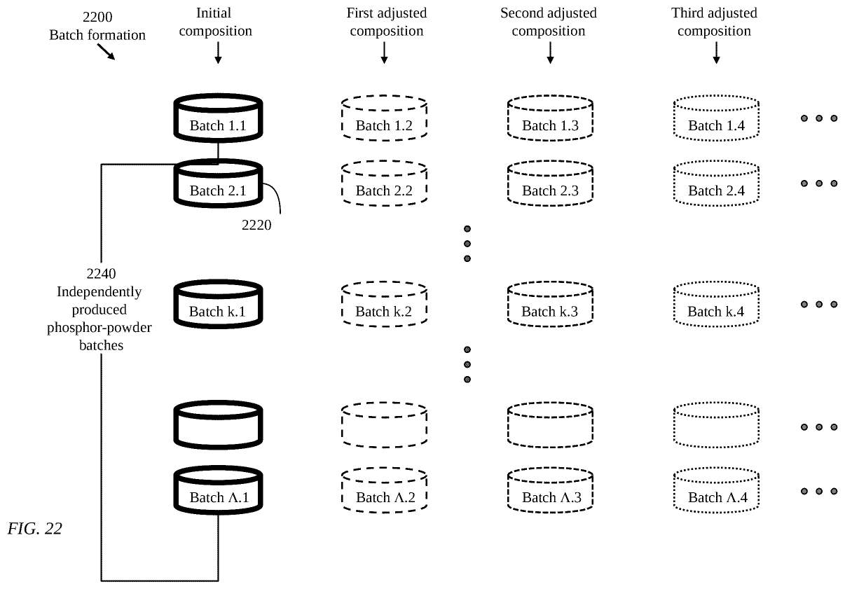

FIG. 22 illustrates an example 2200 of formation and adjustments of batches of fluorescence material for production of backward compatible fluorescence-based temperature sensors. A set 2240 of batches 2220 of distinct mixtures of components are independently produced for determining fluorescence lifetime values (decay-time values) at difference pivotal temperatures. The batches are indexed as 1 to Λ. Λ>1. At each pivotal temperature, the components of a batch may be adjusted in successive steps until a target decay-time is realized. As illustrated, a batch of index k, 1≤k≤Λ, initially of composition k.1 may be adjusted, modifying the proportions of its constituents, to compositions (k.2), (k.3), etc.

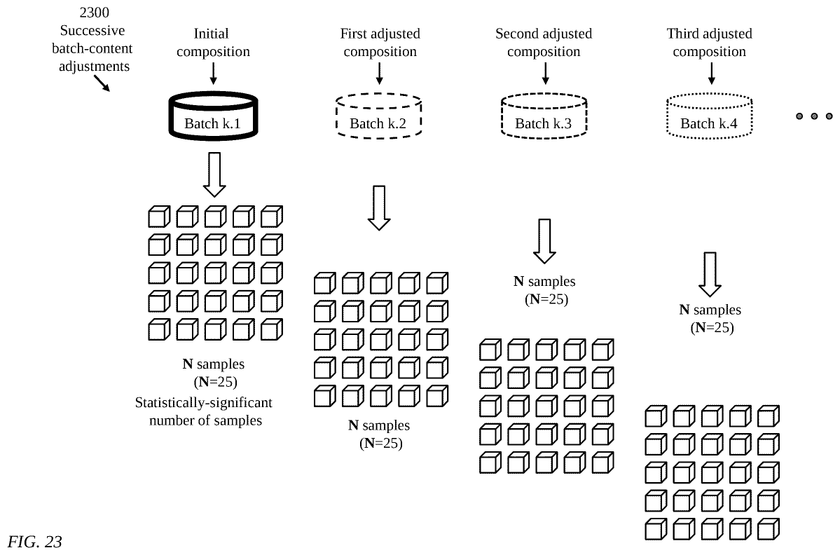

FIG. 23 illustrates an example 2300 of extraction of a number of samples of fluorescence material to be individually subjected to an electromagnetic wave (such as a beam of light) at specified pivotal temperatures. For each pivotal temperature and each content composition, the decay-time of intensity of emitted wave is measured. The number of samples is selected to render statistical analyses of measured decay-times meaningful.

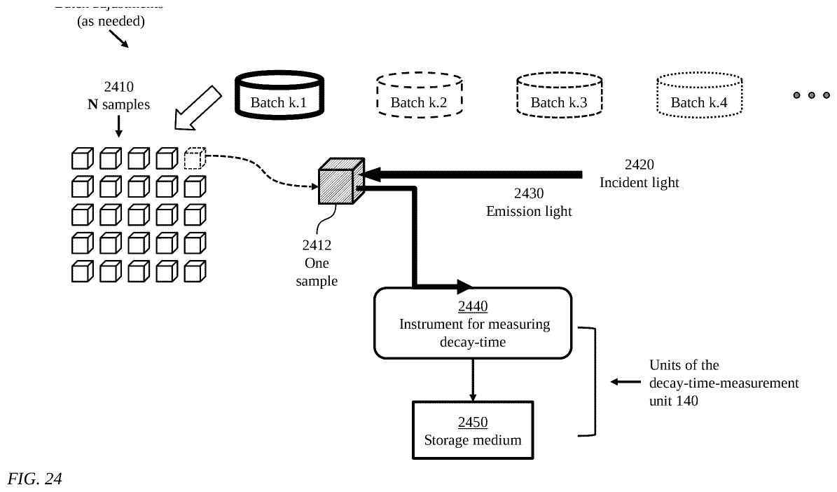

FIG. 24 illustrates testing 2400 of a single sample of a set 2410 of 25 samples of a batch under consideration. A tested sample 2412 is subjected to incident light 2420 of a specified intensity and wavelength. An instrument 2440 measures the decay-time and store relevant data, under control of a microprocessor, in a memory device 2450 for further analysis. The instrument 2440 and the storage medium 2450 are components of the decay-time-measurement unit 140. The figure illustrates testing one sample at a time. However, other arrangements may be feasible.

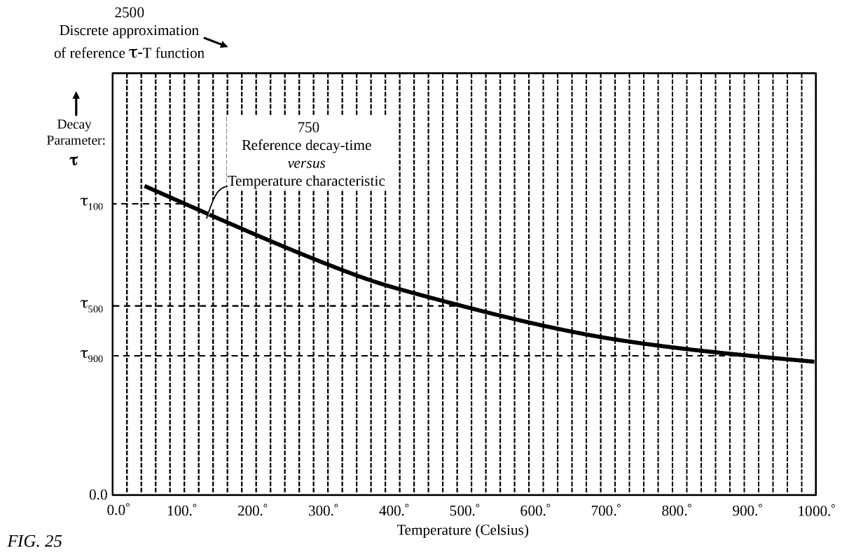

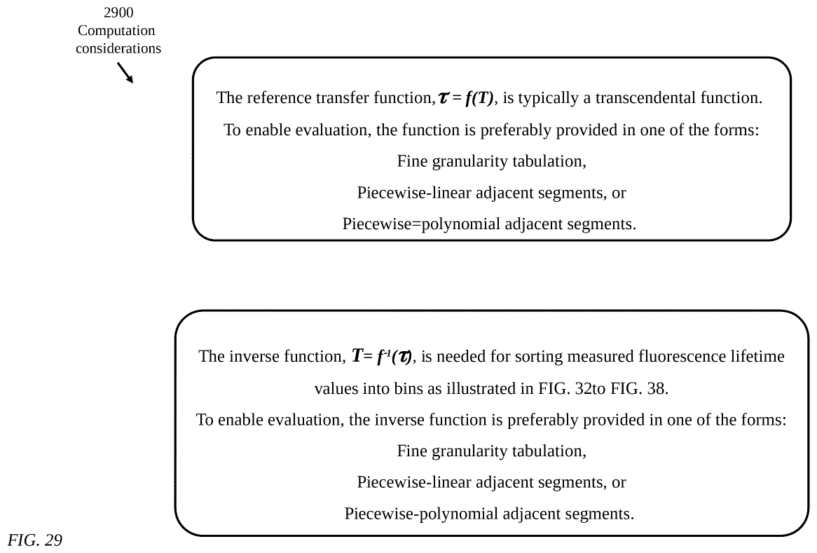

FIG. 25 illustrates discrete approximation 2500 of the reference transfer function 750. The transfer function 750 is typically a transcendental function which would be extensively used as a guideline for producing temperature sensors. Thus, it is preferable that appropriate numerical tabulation of the function be produced and stored in the computation module 160. Alternatively, the function 750 may be approximated as piecewise-linear segments, piecewise-polynomial segments, or a mix of piecewise-linear and piecewise-polynomial segments as illustrated in FIGS. 29, 30, and 31.

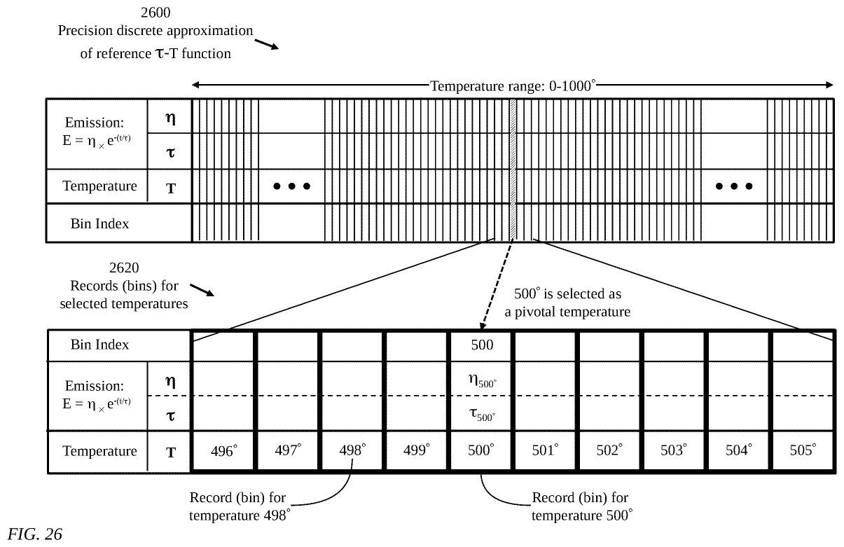

FIG. 26 illustrates precision discrete approximation 2600 of the reference transfer function 750 which is discretized using “bins” 2620 of narrow temperature intervals (1°—wide intervals).

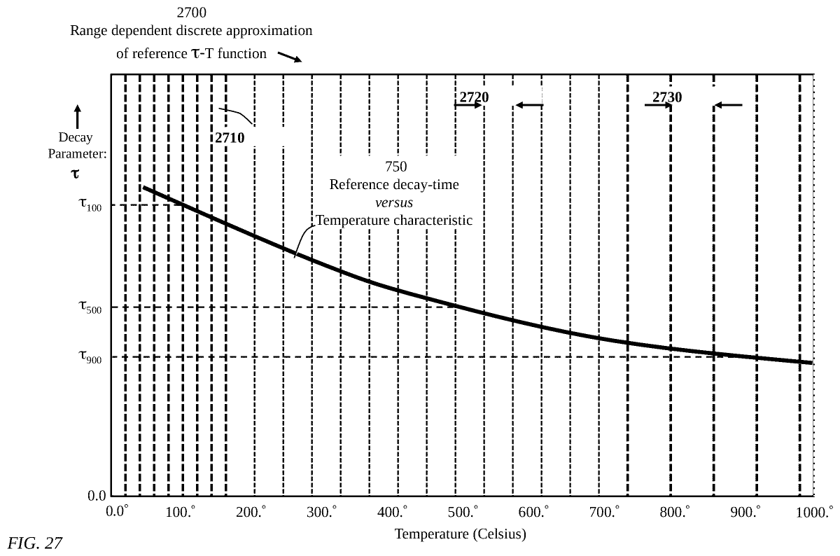

FIG. 27 illustrates range-dependent discrete approximation 2700 of the reference function 750. The function is discretized at intervals 2710, 2720, and 2730 for three ranges of the temperatures.

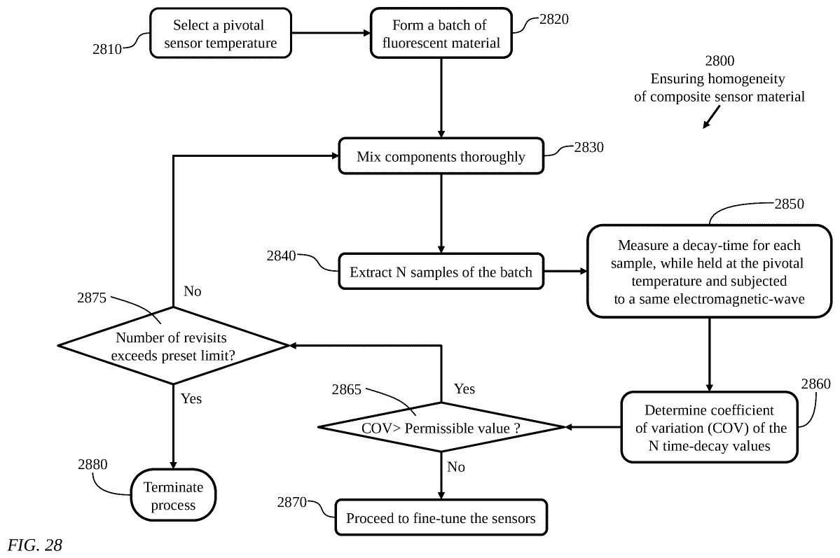

FIG. 28 illustrates a process 2800 of ensuring homogeneity of the fluorescence material based on testing individual samples. Process 2810 selects one of the pivotal temperatures. Process 2820 forms a batch of the fluorescent material. Process 2830 mixes the components of the batch thoroughly. Process 2850 extracts N samples of the batch. As described earlier, the number N is selected to enable meaningful statistical analysis of measurement results. Process 2850 measures a decay-time for each sample, while held at the pivotal temperature and subjected to a same electromagnetic wave (typically light). Process 2860 determines a coefficient of variation (COV) of the resulting decay-time values.

Process 2865 branches to process 2870 if the COV does not exceed a permissible value. Process 2870 submit the sensors for further testing under other pivotal temperatures. If the COV exceeds the permissible COV value, process 2865 branches to process 2875 which determines whether the mixing process 2830 has been performed a number of times that reached a preset limit. If the limit has been reached, the homogeneity of the fluorescent material cannot be assured and process 2800 is terminated. If the limit has not been reached, the cycle of processes 2830, 2840, 2850, 2860, and 2865, is repeated.

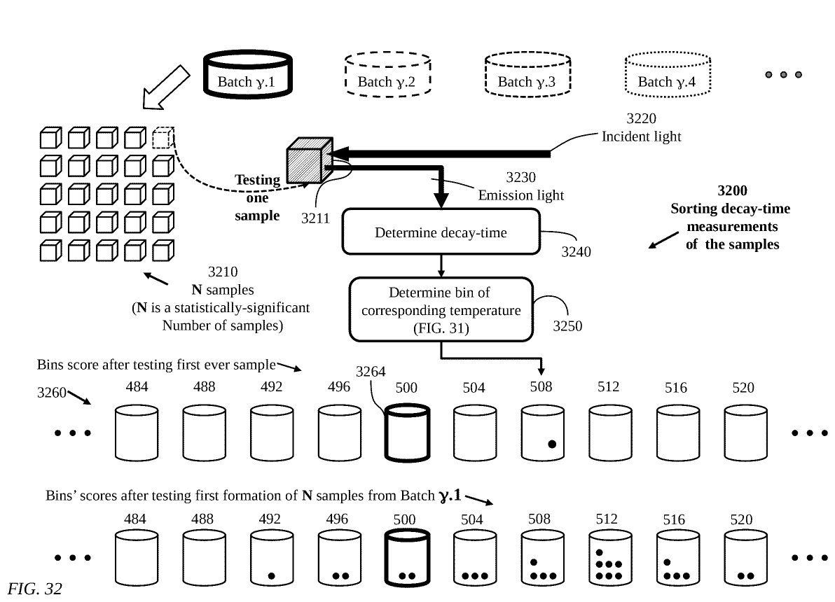

FIG. 29 illustrates representation of the reference transfer function and an inverse of the reference transfer function to expedite computation. The reference transfer function 750, τ=ƒ(T), is typically a transcendental function. To facilitate evaluation of the function at several values of T, the function is preferably provided to the computation unit 160 as one of: a fine-granularity table; a concatenation of piecewise-linear segments; or a concatenation of piecewise-polynomial segments. Likewise, the inverse transfer function T=ƒ⁻¹(τ), which is needed for sorting measured decay-time values into bins (FIG. 32 to FIG. 38) and to indicate temperature for general use, is preferable provided to the computation module 160 in one of the forms mentioned above.

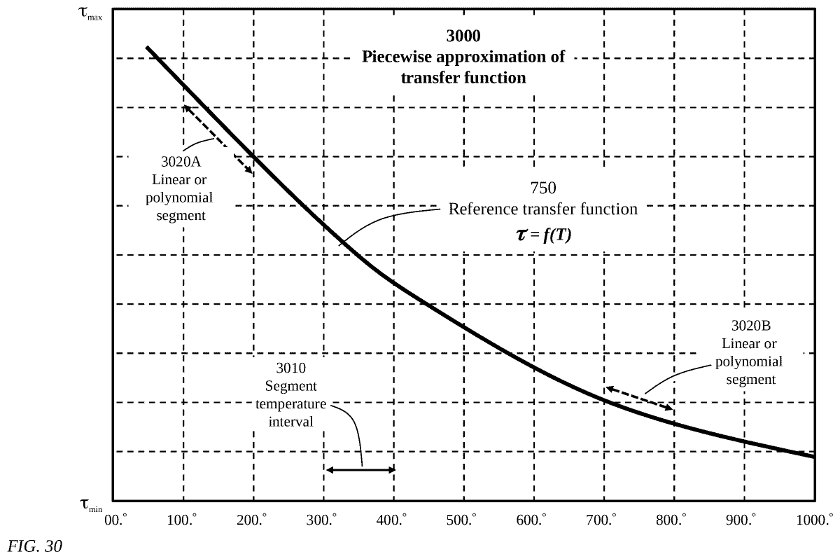

FIG. 30 illustrates an approximation 3000 of the reference transfer function 750 as concatenated piecewise-linear segments or concatenated piecewise-polynomial segments. In the illustrated example, the temperature range of 0.0° to 1000.0° (Celsius) is divided into ten segments 3020 of equal temperature intervals 3010 and each segment may be expressed as a linear function, or a polynomial function, of decay-time versus temperature. Two segments are illustrated, segment 3020A and segment 3020B. It is possible that some segments may be precisely expressed as a linear function while others may require other polynomial forms.

FIG. 30 illustrates a case of dividing the temperature range of interest, 0.0° to 1000.0°, into equal segments of equal temperature intervals. However, it is preferable to divide the temperature range into temperature-dependent segments as illustrated in FIG. 27.

FIG. 31 illustrates an approximation 3100 of an inverse of the reference transfer function 750 as concatenated piecewise-linear segments or concatenated piecewise-polynomial segments. In the illustrated example, the decay-time range τₘᵢₙ to τₘₐₓ is divided into ten segments 3120 of equal durations 3110 and each segment may be expressed as a linear function, or a polynomial function, of decay-time versus temperature. Two segments are illustrated, segment 3120A and segment 3120B. As in the case of FIG. 30, it is possible that some segments may be precisely expressed as a linear function while others may require other polynomial forms.

FIG. 32 illustrates an example 3200 of sorting decay-time measurements of individual samples 3210, extracted from a batch of the fluorescent material, to ascertain homogeneity of the batch of fluorescent material and to determine any need for adjusting the content of the batch. A sample 3211 is held at a specific temperature and subjected to incident electromagnetic wave (such as light) 3220. Process 3240 determines the decay-time of the emitted electromagnetic wave 3230. Process 3250 determines a temperature corresponding to a measured delay-time (as illustrated in FIG. 31) and increases a count of a respective bin 3260. The count associated with the bins represent a histogram with the central temperature of a bin of highest count being the mode of the histogram.

A number of (hypothetical) bins 3260 is used to cover a specified temperature range, with each bin associated with a respective temperature span (only the central temperatures of the successive spans are indicated). In the illustrated example, each bin is associated with respective four degrees (Celsius).

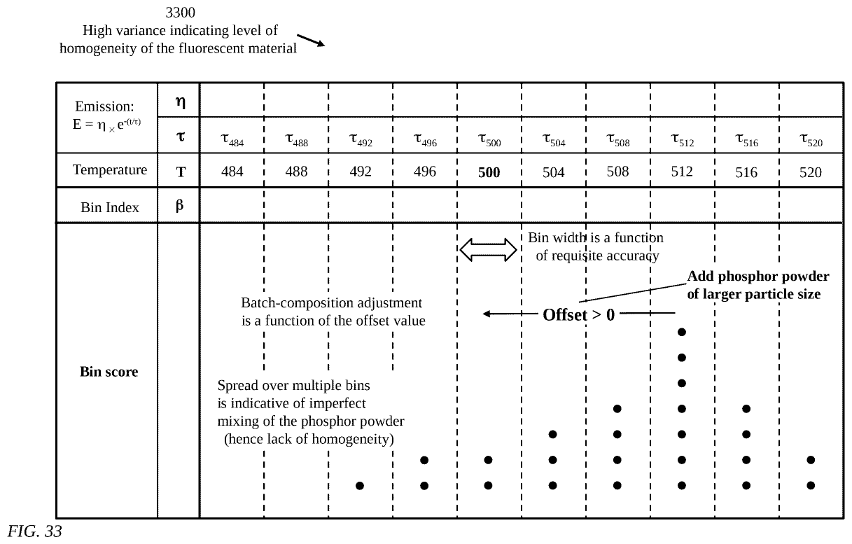

FIG. 33 illustrates a case 3300 of high variance of the contents of individual samples necessitating more thorough mixing of the constituents of the fluorescent material;

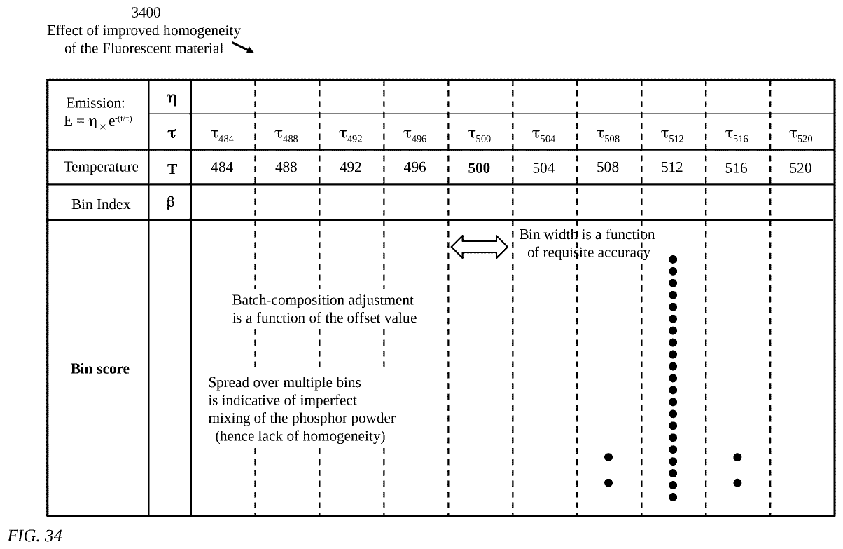

FIG. 34 illustrates a result 3400 of improved mixing of the fluorescence-material contents where the homogeneity is improved but the mode of the distribution still differs significantly from the target mode, thus requiring modifying contents of the fluorescent material. The target mode equals the specific temperature at which the sample is held.

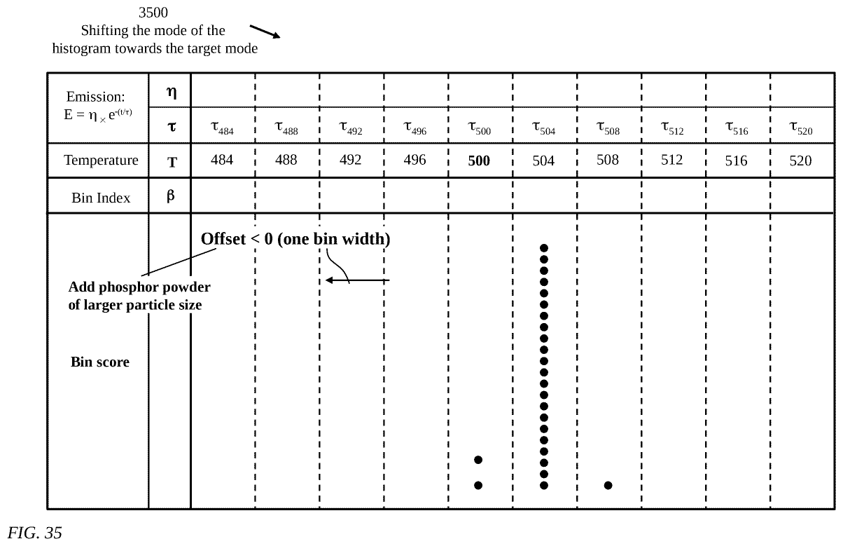

FIG. 35 illustrates improved proximity 3500 of the mode of the distribution to the target mode.

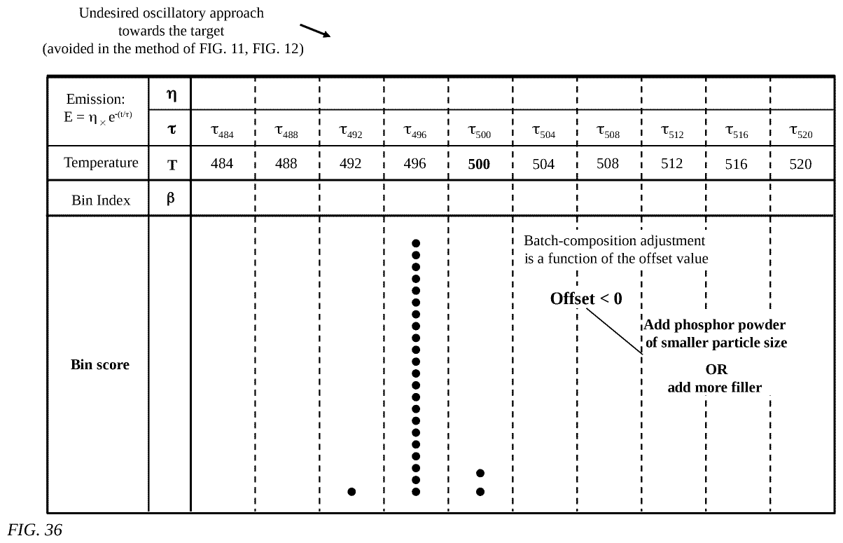

FIG. 36 illustrates a case 3600 of typical oscillatory approach toward the target mode (which is avoided using the method of FIG. 11 and FIG. 12).

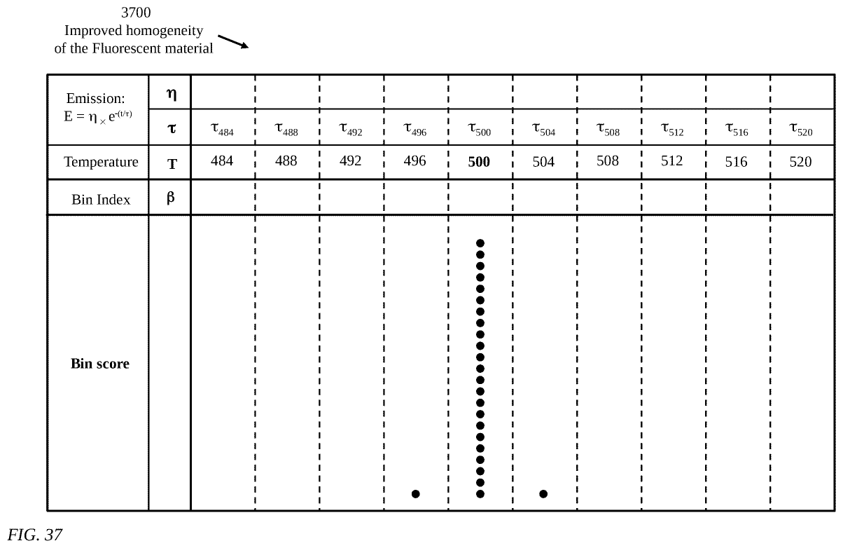

FIG. 37 illustrates a result 3700 of improved homogeneity of the fluorescent material and successful adjustment of the tuning-component concentration for a single pivotal temperature.

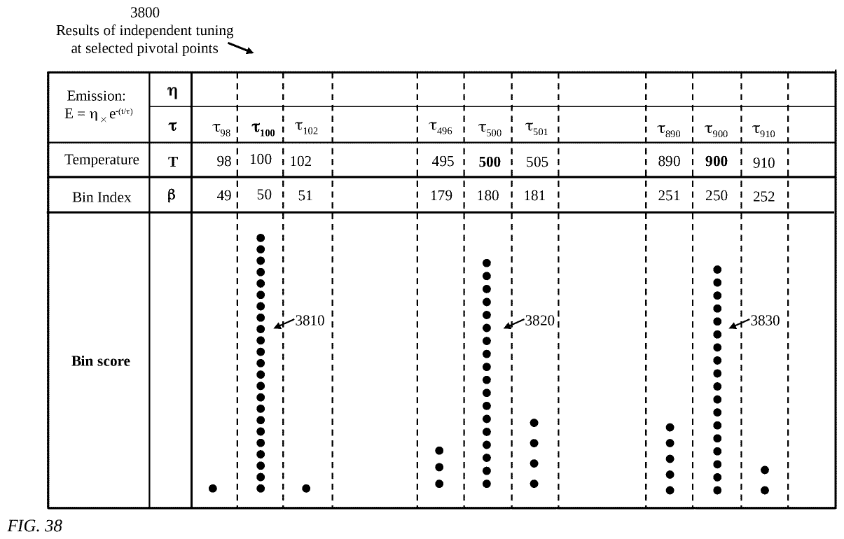

FIG. 38 illustrates results 3800 of independent tuning for three pivotal temperatures of 100°, 500°, and 900°

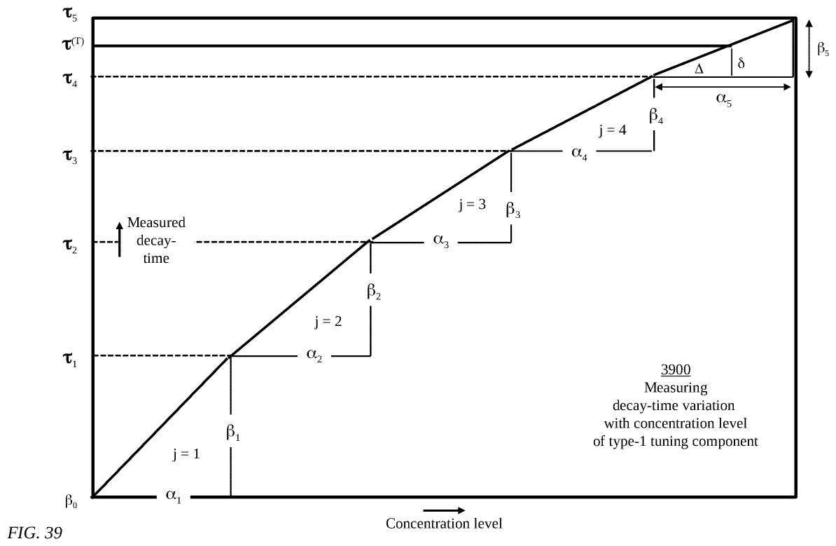

FIG. 39 illustrates an example 3900 of adjusting the concentration level of a type-1 tuning ingredient using successive additions of equal quantities of the tuning ingredient.

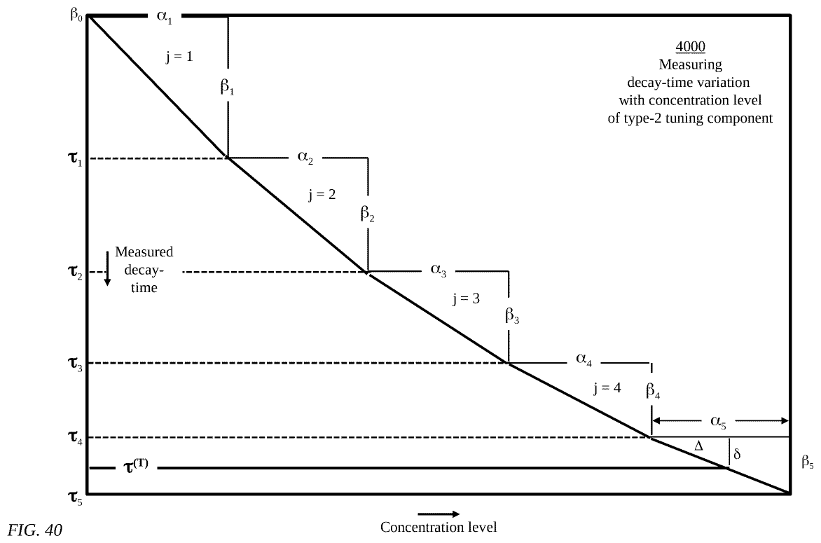

FIG. 40 illustrates an example 4000 of adjusting the concentration level of a type-2 tuning ingredient using successive additions of equal quantities of the tuning ingredient.

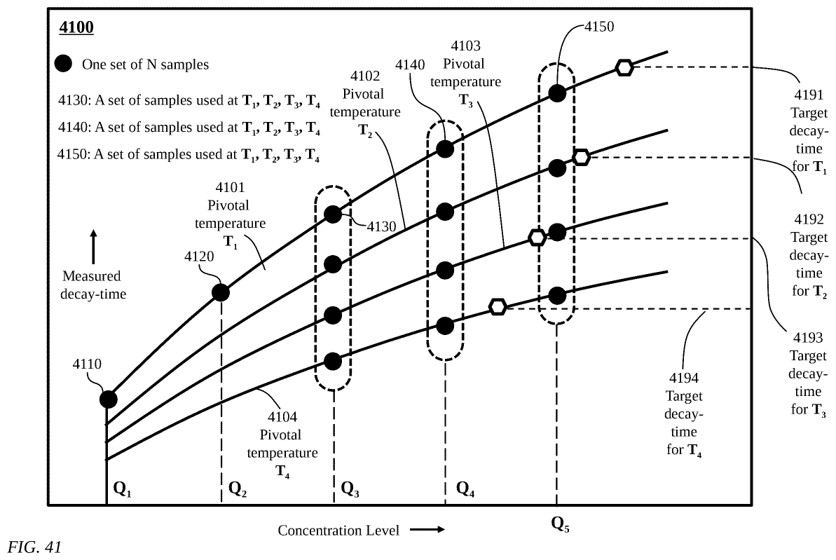

FIG. 41 illustrates an example 4100 of reuse of homogenized batches and corresponding decay-time measurements.

As illustrated in FIG. 17, decay-time values are measured at a set of four pivotal points and a set of five observation temperatures for deriving a transfer function of a fluorescent material and estimating proximity of the derived transfer function from the reference function 750. A pivotal point refers to pivotal temperature and a corresponding decay-time. Likewise, an observation point refers to an observation temperature and a corresponding decay-time. The decay-time values of the pivotal points and observation points define a realized candidate transfer function.

At each pivotal point, the concentration level of a tuning ingredient of fluorescent material is adjusted until the decay-time equals, or closely equals, a corresponding value of the reference transfer function 750. Decay-times at the observation temperatures are then measured and deviations from corresponding values of the reference transfer function 750 are determined and used to derive an indicator of proximity to the reference transfer function.

FIG. 41 illustrates four pivotal temperatures, denoted T₁, T₂, T₃, and T₄. For each pivotal temperature, a concentration level of a tuning ingredient of the fluorescent material is varied until a respective target, according to the reference transfer function 750, is reached. Five concentration levels, denoted Q₁, Q₂, Q₃, Q₄, and Q₅, are illustrated. For each concentration level, a corresponding batch of the fluorescent material is formed and thoroughly mixed to ensure homogeneity of the content. A number of samples, referenced collectively as a set of samples, are then extracted and used to measure the decay-time corresponding to the concentration level. Five sets of samples are produced, referenced as 4110, 4120, 4130, 4149, and 4150 of concentrations Q₁, Q₂, Q₃, Q₄, and Q₅, respectively, are produced.

For the pivotal temperature T₁, the target decay-time τ^{(T1)}, reference 4191, is determined from the reference transfer function 750. At concentration level Q₅, the measured decay-time of the set 4150 is found to be sufficiently close to the target value and the concentration level is then adjusted to reach the target value as illustrated in FIG. 11.

For the pivotal temperature T₂, T₂>T₁, the target decay-time 4192 is less than the target decay-time for T₁. If the five sets of samples 4110, 4120, 4130, 4140, and 4150 are held at temperature T₂, the corresponding decay-times would be lower than corresponding delay times at temperature T₁. The values of both the target decay-time and the measured decay-time are reduced since T₂>T₁, and the require concentration level can be calculated using interpolation of decay-time measurements of the sets of samples of concentrations Q₃, Q₄, and Q₅.

Likewise, for the pivotal temperature T₃ and T₄ the needed concentrated adjustments can be determined using the same sample sets 4130, 4140, and 4150 and interpolation of decay-time measurements.

While the above noted embodiments have been described with regard to fluorescence sensors based on the fluorescence phenomenon, it is understood that the embodiments of the present invention are also applicable to phosphorescence sensors utilizing phosphorescence phenomenon.

Although the embodiments of the invention has been described in detail, it will be apparent to one skilled in the art that variations and modifications to the embodiment may be made within the scope of the following claims.

1. A method of producing fluorescence-based temperature sensors, implemented in a system performing chemical-processing, fluorescence decay-time measurement, and computation, the method comprising:
acquiring a reference transfer function relating fluorescence decay-time to temperature over a temperature range;
determining a set of pivotal temperatures and a set of observation temperatures within the temperature range;
for each pivotal temperature:
forming a batch of fluorescence material comprising a tuning ingredient;
determining, from the reference transfer function, a target decay-time corresponding to said each pivotal temperature;
iteratively:
extracting a set of samples from the batch;
measuring a current fluorescence decay-time of the set of samples;
where the current decay-time differs from the target decay-time, adjusting concentration level of the tuning ingredient of the batch and repeat said extracting until the target decay-time is reached at an appropriate concentration level;
gauging observation fluorescence decay-times of the set of samples at the observation temperatures;
determining:
deviations of the observation fluorescence decay-times from corresponding values of the reference transfer functions; and
a deviation indicator;
and
deducing an optimal concentration level based on values of the appropriate concentration level and respective deviation indicators corresponding to the pivotal temperatures; and
using said fluorescent material with said optimal concentration level of the tuning ingredient to produce said temperature sensors.

2. The method of claim 1 wherein said deducing comprises one of:
determining said optimal concentration level as a value of said appropriate concentration corresponding a least deviation indicator; and
interpolating resulting pairs of deviation indicators and appropriate concentration levels to determine said optimal concentration level that corresponds to a minimum deviation indicator.

3. The method of claim 1 wherein said adjusting comprises increasing a concentration level of the tuning ingredient according to equal increments, measuring resulting fluorescence decay-times, with a last increment calculated to yield a fluorescence decay-time equal to a target decay-time.

4. The method of claim 1 wherein said adjusting comprises: increasing a concentration level of the tuning ingredient according to adaptively determined increments, measuring resulting fluorescence decay-times, with a last increment calculated to yield a fluorescence decay-time equal to a target decay-time, each adaptively determine increment being a function of prior increments and corresponding fluorescent decay-times.

5. The method of claim 1 wherein the set of pivotal temperatures and the set of observation temperatures are interleaved with optional coincidence of at least one temperature of each set.

6. The method of claim 1 further comprising selecting said tuning ingredient that causes a monotonic change of the fluorescent decay-time over said temperature range.

7. The method of claim 1 wherein said deviation indicator is a mean value of the magnitudes of said deviations of the observation fluorescence decay-times over the set of observation temperatures.

8. The method of claim 1 further comprising selecting an appropriate number of samples of the set of samples to produce a statistically significant calculation of fluorescence decay-time of the fluorescent material based on individual measurements of decay-times of individual samples.

9. The method of claim 8 further comprising determining said fluorescence decay-time of the fluorescent material as a mean value of measurements of fluorescence decay-times of individual samples of the set of samples.

10. The method of claim 8 further comprising sorting said measurements of fluorescence decay-times of individual samples of the set of samples into a histogram of temperature intervals and determining said fluorescence decay-time of the fluorescent material as a mode of the histogram.

11. The method of claim 8 further comprising, for at least a first of said each pivotal temperature:
determining a coefficient-of-variation (COV) of current fluorescence decay-times of individual samples;
where the COV exceeds a permissible limit, mixing the ingredients of the fluorescent material to reduce the COV;
thereby ensuring homogeneity of the fluorescence material.

12. The method of claim 1 further comprising approximating said reference transfer function as one of:
concatenated piecewise-linear segments;
concatenated piecewise-polynomial segments; and
concatenated piecewise-linear segments and piecewise-polynomial segments;
thereby facilitating determination of target decay-times corresponding to temperatures of the fluorescent material.

13. The method of claim 1 further comprising approximating an inverse of said reference transfer function as one of:
concatenated piecewise-linear segments;
concatenated piecewise-polynomial segments; and
concatenated piecewise-linear segments and piecewise-polynomial segments;
thereby facilitating translation of fluorescence decay-time measurements to temperatures of the fluorescent material.

14. The method of claim 1 wherein tuning is performed for narrower temperature ranges.

15. The method of claim 1 further comprising approximating said reference transfer function over temperature segments of different temperature intervals.

16. The method of claim 1 further comprising retaining batches of said appropriate concentration levels and corresponding decay-time measurements, produced during processes performed for each pivotal temperature for potential reuse in determining said optimal concentration level.

17. A system for producing fluorescence-based temperature sensors, comprising:
a chemical-processing unit;
a decay-time measurement unit; and
a computation unit;
the chemical-processing unit is configured to:
form a batch of fluorescence material comprising a tuning ingredient;
adjust concentration of the tuning ingredients according to instructions from the computing unit; and
extract sets of samples from the batch;
the decay-time measuring unit is configured to measure decay-times of the sets of samples at each of selected temperatures and communicate the decay-time measurements to the computation unit;
the computation unit is configured to:
acquire a reference transfer function relating decay-time to temperature over a temperature range;
determine, from the reference transfer function, for the selected temperatures, respective target decay-times;
receive said decay-time measurements;
determine requisite adjustments of concentration level of the tuning ingredient of the batch to reach said respective target decay-times;
communicate the requisite adjustments to the chemical-processing unit; and
deduce an optimal concentration level based on received decay-time measurements;
use said fluorescent material with said optimal concentration level of the tuning ingredient to produce said temperature sensors.

18. The system of claim 17 further comprising a controller for orchestrating interactive processes performed at said chemical-processing unit, decay-time measurement unit, and computation unit.

19. The system of claim 17 wherein the selected temperatures comprise a set of pivotal temperatures and a set of observation temperatures within the temperature range, so that:
at a pivotal temperature, the fluorescent material is adjusted so that the decay-time equals a target value based on the reference transfer function; and
deviation of a transfer function, relating decay-times to temperatures of the adjusted fluorescent material, from the reference transfer function, is determined at the observation temperatures from which a deviation indicator is determined.

20. The system of claim 17 wherein said tuning ingredient is selected to cause a monotonic change of the fluorescent decay-time over said temperature range.
